(19) United States
(12) Patent Application Publication
(10) Pub. No.: US 2026/0180192 A1
(43) Pub. Date: Jun. 25, 2026

(54) TIGHTLY-COUPLED DIPOLE ANTENNA WITH COMMON-MODE RESONANCE SUPPRESSION

(71) Applicant: The Chinese University of Hong Kong, Shatin (CN)

(72) Inventors: Hao Cheng, Fanling (CN); Steven Gao, Ma On Shan (CN)

(21) Appl. No.: 19/429,266

(22) Filed: Dec. 22, 2025

Related U.S. Application Data
(60) Provisional application No. 63/738,241, filed on Dec. 23, 2024.

(51) Int. Cl. H01Q 13/16; H01Q 5/48; H01Q 15/00

(52) U.S. Cl. CPC H01Q 13/16; H01Q 5/48; H01Q 15/0013

(57) ABSTRACT

Systems and methods for a tightly coupled dipole antenna are described herein. Embodiments can include a dipole antenna with a first and second conductor. The first and second conductor can have a conductive arm attached to a respective conductor end. Other features can include an inductor attached to another end of the first conductor and the second conductor to suppress common mode resonance of the dipole antenna. A method of suppressing common mode resonance of a dipole antenna can include: generating a circuit load representation of dipole arms; simulating connection of a first end of the circuit load representation to a first conductor representation and a second end of the circuit load representation to a second conductor representation; simulating a short across the first and second conductor representation; determining a parallel admittance across the circuit load representation; and determining a common mode resonance frequency of the dipole antenna.

### CROSS-REFERENCE TO RELATED APPLICATIONS

This application claims the benefit of U.S. Provisional Patent Application No. 63/738,241, filed Dec. 23, 2024, entitled “TIGHTLY-COUPLED DIPOLE ANTENNA WITH COMMON-MODE RESONANCE SUPPRESSION,” the entire disclosure of which is hereby incorporated by reference in its entirety.

### TECHNICAL FIELD

The present disclosure generally relates to a dipole antenna with common mode resonance suppression. For example, aspects of the present disclosure relate to systems and techniques for a tightly-coupled dipole array antenna with common mode resonance suppression techniques (e.g., an inductor).

### BACKGROUND

Ultra-wideband (UWB) or wideband antennas and arrays can be used in wideband or multi-band wireless signaling systems (also referred to as wireless systems), such as mobile communication base stations, radar systems, through-wall imaging, sensing, and security. The trend of wireless system is to employ more and more frequency bands thus UWB or wideband antennas are required. The first generation of communication systems (1G) launched in 1982, followed by updates every ten years. 1G was analog and 2G was digital, using 800/900/1800 MHz. 3G offered faster speeds, operating at 800 MHz to 2100 MHz, and 4G uses 600 MHz to 2.6 GHz to improv data speeds further. 5G provides even greater capacity and lower latency, using frequencies from 600 MHz to 6 GHz and millimeter-wave frequencies such as 24-40 GHz bands. Antennas for communication applications generally attempt to support both new and existing bands. However, coexisting of multiple antennas at base stations can be challenging due to interference and limited space, which greatly degrade performance.

### BRIEF SUMMARY

Systems, techniques, apparatuses, processes (also referred to as methods), computer readable media, and electronic devices (collectively referred to herein as systems and techniques) are described herein for constructing, simulating, building, and using a dipole antenna and dipole antenna array (e.g., a TCDA array). For example, the systems and techniques include a method of suppressing common mode (CM) resonance using CM inductors. Additionally, a design and design methodology of TCDA is described. The design and design methodology includes combining the use of CM inductors and sliced tapered-slot antenna including or made of a frequency selective surface (FSS). The systems and techniques further include a cavity model for CM resonance, a method for predicting CM frequency of a dipole antenna, a method for using inductors (e.g., CM inductors) for CM suppression, and a new method of designing TCDA for UWB performance. The TCDA design can provide improvements to beam-scanning performance of the TCDA (e.g., improvements to scan coverage). Further, as compared with existing UWB arrays such as Vivaldi antenna and horn-based UWB antenna arrays, the proposed TCDA design may be more compact in size (e.g., smaller), low cost (e.g., fewer materials used), lighter weight, and/or manufacturable using standard Printed Circuit Board (PCB) technology. The systems and techniques provide a mass manufacturable and scalable design.

Embodiments described herein include a dipole antenna with an inductor connected to conductors of the dipole antenna to suppress common mode frequency of the dipole antenna. The dipole antenna can be part of an antenna array, such as a tightly-coupled dipole antenna (TCDA) array. The dipole antenna can include two conductors (e.g., two conductive elements) with each conductor including a corresponding conductive arm. The two conductors can be substantially in parallel along a first plane. In some examples, conductive arms can be connected to an end of a corresponding conductor in a direction perpendicular to the conductor and along the first plane. The inductor can be connected to another end of the two conductors. The inductor can be used to substantially suppress or substantially filter common mode resonance frequency of the dipole antenna. In further examples, the conductive arms are part of a respective conductor. The embodiments present in this disclosure can include a substrate to which the dipole antenna, or a plurality of dipole antennas, can be attached, printed on, or otherwise connected to. The substrate can be oriented along the first plane.

In further embodiments, an additional dipole antenna can be attached to the substrate or an additional substrate to construct an antenna array. For example, the antenna array can be a tightly coupled dipole antenna (TCDA) array. In some examples, a conductive arm of a first dipole antenna can overlap with a conductive arm of a second dipole antenna. In such an example, the conductive arms of the first dipole antenna and the second dipole antenna can overlap on opposing sides of the substrate. In other examples, the conductive arms can be physically connected. In further examples, the dipole antenna can include an additional substrate positioned along a second plane orthogonal to the first plane. In some examples, the second substrate can be a ground of the dipole antenna and can be made of a different material than the first substrate. The thickness of the substrates can vary based on materials used. For example, the first substrate can be less than 0.8 millimeters (mm). In such an example, the first substrate can be made of a material such as RT/duroid 5880. In some examples, the second substrate can be made of a material such as FR4 KB-6160.

In further embodiments, an additional antenna can be connected to the substrate. For example, a tapered-slot antenna (such as a Vivaldi antenna) can be attached to the substrate. In such an example, the tapered-slot antenna can be substantially in parallel with the conductive arms of the dipole antenna. In some embodiments, the tapered-slot antenna can be divided into a plurality of portions (e.g., different sections) with gaps between adjacent portions. The divisions of the portions of the tapered-slot antenna can be in a direction parallel to the conductive arms. For example, by dividing the tapered slot antenna in a direction parallel to the conductive arms, the tapered-slot antenna can suppress or otherwise reduce common mode resonance by inducing an electric field orthogonal to the dipole antenna (e.g., because current can then generally flow in the direction of the divisions of the tapered-slot antenna), as opposed to in the direction of the conductors of the dipole antenna causing common mode resonance. In some examples, the tapered-slot antenna can include a frequency selective surface (FSS). For example, the FSS can be a surface selected based on a determined common resonance or resonant frequency of the dipole antenna.

In a further embodiment, methods of determining and suppressing common mode resonance of a dipole antenna are described herein. For example, the method can include analyzing orthogonal modes of equivalent rectangular coaxial waveguide, determining resonant modes and field distributions of a cavity resonator formed by applying (e.g., simulating or modeling) perfect electric conductor (PEC) and open boundary characteristics in the direction of wave propagation of a dipole antenna (or portion of the dipole antenna) being modeled, and determining (e.g., simulating or modeling) loaded dipole arms of the dipole antenna to determine the common mode (CM) frequency of the dipole antenna.

In a further embodiment, the method can include generating a circuit load representation of dipole arms of the dipole antenna, including an inductance and capacitance substantially matching the inductance and capacitance of the dipole arms; simulating connection of a first end of the circuit load representation to a first conductor representation and a second end of the circuit load representation to a second conductor representation, wherein the first conductor representation and the second conductor representation substantially match a length of conductors of the dipole antenna; simulating a short across the first conductor representation and the second conductor representation to form a closed circuit; determining a parallel admittance across the circuit load representation; and determining, based on the parallel admittance of the circuit load representation, a common mode resonance frequency of the dipole antenna. The method can further include measuring inductance and capacitance of the dipole arms of the dipole antenna. In further embodiments, the method can include constructing an inductor or resonator based on the common mode frequency and applying the inductor or resonator to conductors of the dipole antenna. For example, the method can include generating a resonator based on the parallel admittance of the circuit load representation, the resonator having a parallel admittance substantially matching the parallel admittance of the circuit load representation; and simulating application of the resonator to the dipole antenna. In some embodiments, the resonator is an inductor or includes an inductor. In some examples, the connection of the resonator or inductor to the conductors of the dipole antenna is simulated, such as a part of a computer program or application. In further embodiments, the circuit load representation of the dipole arms is an inductor-capacitor (LC) circuit. For example, the LC circuit can include a first circuit, and a second circuit connected in parallel. In such an example the first circuit can include a first capacitor and a first inductor in series, and the second circuit can include a second capacitor and a second inductor in series. In another example, the first circuit can be associated with a first dipole arm of the dipole antenna and the second circuit can be associated with a second dipole arm of the dipole antenna.

In another embodiments, a method for constructing and using a dipole antenna configured to suppress common mode resonance of the dipole antenna. The method can include receiving a radio frequency signal by a dipole antenna; generating, based the radio frequency signal, a current through a first conductor and a second conductor of the dipole antenna; and suppressing a common mode resonance frequency associated with the current using an inductor, wherein the inductor is connected to an end of the first conductor and an end of the second conductor. In such an example, the first conductor can include a first conductive arm connected substantially perpendicular to a first end of the first conductor and oriented along a first plane, and a second conductive arm connected substantially perpendicular to a first end of the second conductor and oriented along the first plane. The method can further include receiving an additional radio frequency signal by a tapered-slot antenna, the tapered-slot antenna divided into a plurality of portions with gaps between adjacent portion, wherein the divisions are substantially parallel to the first conductive arm and the second conductive arm; and generating, based on the additional radio frequency signal, an additional current through a portion of the tapered-slot antenna in a direction perpendicular to the current through the first conductor and the second conductor. In another example, the tapered-slot antenna can be divided into a plurality of portions with gaps between adjacent portions. In a further example, the tapered-slot antenna can be divided into portions in a direction perpendicular to the first conductor and the second conductor. In some examples, the tapered slot antenna includes a frequency selective surface (FSS).

A better understanding of the nature and advantages of embodiments of the present invention may be gained with reference to the following detailed description and the accompanying drawings.

### BRIEF DESCRIPTION OF FIGURES

FIG. 1 illustrates common mode resonance in a graph and a tightly-coupled dipole array (TCDA), according to embodiments of the present invention.

FIG. 2 illustrates a set of models for simulating or modelling a dipole antenna, according to embodiments of the present invention.

FIG. 3 illustrates a block diagram of illustrating a sub-division of a rectangular coaxial waveguide, according to embodiments of the present invention.

FIG. 4 is a plot diagram of an n by n determinant of matrix Eᵣₙ, according to embodiments of the present invention.

FIG. 5 illustrates set of block diagrams including a first block diagram representing an example electric field distributions of a cavity model plotted across selected planes of the cavity model and a second block diagram representing an example magnetic field distribution plotted across selected planes of the cavity model, according to embodiments of the present invention.

FIG. 6 illustrates an example equivalent circuit of a dipole antenna, according to embodiments of the present invention.

FIG. 7 is a block diagram illustrating a dipole antenna of a tightly-coupled dipole antenna (TCDA) array, according to embodiments of the present invention.

FIG. 8 is a block diagram including a first line graph illustrating admittance of a dipole antenna over different frequencies and a second line graph illustrating admittance of a dipole antenna with various dielectric constants and thicknesses of a substrate, according to embodiments of the present invention.

FIG. 9 illustrates a first dipole model in common mode, a second dipole model with a common mode inductor in differential mode (DM), and an equivalent circuit representation of the second dipole model, according to embodiments of the present invention.

FIG. 10 is a line graph of a function representing admittance of a common mode inductor applied to a dipole antenna, according to embodiments of the present invention.

FIG. 11 is a block diagram illustrating a process for suppressing CM resonance of a dipole antenna and applying a tapered slot antenna to the dipole antenna, according to embodiments of the present invention.

FIG. 12 is a block diagram including a first line graph illustrating input impedance of a dipole antenna with a tapered-slot antenna, without a tapered-slot antenna, and with a sliced tapered-slot antenna, according to embodiments of the present invention.

FIG. 13 illustrates an example tightly coupled dipole antenna (TCDA) array including a plurality of dipole antennas attached (or printed in or on) to a first substrate oriented along a first plane, according to embodiments of the present invention.

FIG. 14 is a flowchart of an example process for predicting and suppressing common mode resonance, according to embodiments of the present invention.

FIG. 15 is a flowchart of an example process for predicting and suppressing common mode resonance, according to embodiments of the present invention.

FIG. 16 is a block diagram illustrating an example computing system for performing the techniques, operations, processes, and methods described herein.

### TERMS

“Ultra-wideband (UWB)” corresponds to radio technology using a range of frequencies. UWB generally corresponds to frequencies ranging from 3.1 gigahertz (GHz) to 10.6 GHz. “UWB antennas” and “UWB antenna arrays” can correspond to antennas and antenna arrays configured to receive or capture signals with frequencies from 3.1 GHz to 10.6 GHz.

A “frequency selective surface (FSS)” corresponds to a surface configured to reflect, transmit, or absorb electromagnetic fields. The FSS can be a composite material, such as being a substantially flat metal screen or including a metal screen configured to reflect, transmit, or absorb electromagnetic fields based on the frequency of received signals. Antennas can include or can be made of FSS to suppress unwanted radiation of signals from the antennas. For example, a tapered slot antenna can be made of the FSS.

A “dipole antenna” corresponds to an antenna with two conductive elements (e.g., two wires, two conductors, etc.). The two conductive elements can be separated by a gap and can be aligned in parallel. The dipole antenna can conductive arms attached or connected to the conductive elements. In some examples, the conductive arms are part of the conductive arms. In such an example, the conductive element can include a curvature at an end of the conductive elements to be the conductive arms.

A “tightly-coupled dipole array (TCDA)” corresponds to a system, device, or apparatus including a plurality of dipole antennas. The dipole antennas can be coupled using electromagnetic fields. For example, “tightly coupled” can include elements (e.g., the dipole antennas) positioned close enough that near-field electromagnetic interactions of the dipole antennas can affect the flow of electricity or output of signals of the elements. A “unit cell” can correspond to a repeating section of an antenna array (e.g., the dipole antennas, a single dipole conductor or conductive element, etc.). The unit cell can include dipole spacing, length, ground plane substrate, and other substrates.

“Common mode resonance” corresponds to behavior or phenomena of electrical systems (e.g., circuits, antennas, etc.) where amplitude oscillations occur at a specific frequency (e.g., “a common mode frequency” of the electrical system). “Common mode signals” can correspond to signals (e.g., current) flowing in the same direction in a pair of conductors (e.g., current flowing the same direction in two conductors of a dipole antenna).

A “cavity model” corresponds to a mathematical or physical representation of an enclosed or partially enclosed space. Cavity models can include representations of phenomena such as electromagnetic waves, currents, voltages, etc. Cavity models can be physically constructed, determined, or simulated using a computing device.

A “resonator” corresponds to a device or component that exhibits resonant behavior. For example, a resonator can suppress oscillations (e.g., electromagnetic signals, current oscillations, etc.) at specific frequencies. A resonator can be used to filter signals of specific frequencies. A “common mode inductor” or “CM inductor” corresponds to an inductor to suppress (e.g., reduce, remove, mitigate) common mode currents in an electrical system (e.g., a circuit, antenna, antenna array, etc.). A resonator can include or can be a common mode inductor. A “cavity resonator” is a resonator constructed as part of a cavity model.

A “substrate” corresponds to a material which elements can be attached to or within to provide structural support and electrical connectivity between the elements. For example, the dipole antenna can be mounted, connected, or attached to multiple substrates.

A “threshold” can refer to predetermined numbers used in an operation. For example, a threshold value can be a value above or below which a particular classification applies. Either of these terms can be used in either of these contexts. Such a threshold value can be determined in various ways, as will be appreciated by the skilled person. For example, metrics can be determined for two different cohorts of subjects with different known classifications, and a threshold value can be selected as representative of one classification (e.g., a mean) or a value that is between two clusters of the metrics (e.g., chosen to obtain a desired sensitivity and specificity). As another example, a threshold value can be determined based on statistical analyses or simulations of samples.

The term “about,” “substantially”, and “approximately” can mean within an acceptable error range for the particular value as determined by one of ordinary skill in the art, which will depend in part on how the value is measured or determined, i.e., the limitations of the measurement system. For example, “about” or “approximately” can mean within 1 or more than 1 standard deviation, per the practice in the art. Alternatively, “about” can mean a range of up to 20%, up to 10%, up to 5%, or up to 1% of a given value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%. “Substantially” can mean for the most part or essentially. For example, two elements which are “substantially parallel” can mean that the two elements do not intersect and are placed at about a continuous distance apart for the length of the element.

### DETAILED DESCRIPTION

Certain aspects and embodiments of this disclosure are provided below. Some of these aspects and embodiments can be applied independently. Some of these aspects and embodiments can be applied in combination as would be apparent to those of skill in the art. In the following description, specific details are set forth in order to provide a thorough understanding of embodiments and examples of the application. However, it will be apparent that various embodiments, aspects, and examples may be practiced without these specific details. The figures, description, embodiments, aspects, and examples are not intended to be restrictive.

As previously mentioned, ultra-wideband (UWB) antennas and arrays can be used in various wireless signaling systems (wideband or multi-band wireless systems), such as mobile communication base stations, radar systems, through-wall imaging, sensing, security, etc. Many wireless signaling systems (also referred to as wireless systems incorporate more and more frequency bands thus requiring UWB or wideband antennas. The first generation of communication systems (1G) launched in 1982, followed by updates every ten years. 1G was analog and 2G was digital, using 800/900/1800 MHz. 3G offered faster speeds, operating at 800 MHz to 2100 MHz, and 4G uses 600 MHz to 2.6 GHz to improv data speeds further. 5G provides even greater capacity and lower latency, using frequencies from 600 MHz to 6 GHz and millimeter-wave frequencies such as 24-40 GHz bands. Antennas for communication applications generally attempt to support both existing bands and future frequency bands. However, coexistence of multiple antennas at base stations is challenging due to interference and limited space, which greatly degrade performance. Thus, a single UWB array antenna capable of covering many frequency bands is required for mobile communication base stations.

UWB array antennas can be configured to support Integrated Sensing and Communication (ISAC) to provide localization and imaging during communication. UWB array antennas can further be used in radar for diagnosis, through-the-wall imaging, traffic control, and security systems. Many UWB array antennas have been developed using a variety of UWB antennas (also referred to as elements) such as Vivaldi antennas, horn, or spiral antennas, etc. However, current UWB antennas and arrays are bulky, heavy, and expensive, generally limiting the usage to fixed locations. The size, weight, and expensive nature of UWB antennas further limits large scale deployment of wireless systems incorporating UWB antennas.

Tightly-coupled dipole array (TCDA) antennas can be used instead of or in addition to UWB arrays and UWB phased array antenna systems. TCDA are generally smaller than UWB antennas using UWB components (Vivaldi, horn, spiral antennas, etc.). TCDA however are susceptible to disruptions to impedance bandwidth due to common mode (CM) resonance from symmetrical current distributions. For example, because TCDA employ dipole antennas, some received signal frequencies can cause symmetrical current distributions of the dipole antennas causing disruptions, errors, and noise. Further, TCDA unit cells generally include a high input impedance, such as an input impedance of about or roughly 200Ω (ohm). The high input impedance can cause communication issues when matching (e.g., impedance matching between source and load) with a 50Ω port over a UWB frequency band.

Systems, techniques, apparatuses, processes (also referred to as methods), computer readable media, and electronic devices (collectively referred to herein as systems and techniques) are described herein for constructing, simulating, building, and using a dipole antenna and dipole antenna array (e.g., a TCDA array). For example, the systems and techniques include a method of suppressing common mode (CM) resonance using CM inductors. Additionally, a design and design methodology of TCDA is described. The design and design methodology includes combining the use of CM inductors and sliced tapered-slot antenna including or made of a frequency selective surface (FSS). The systems and techniques further include a cavity model for CM resonance, a method for predicting CM frequency of a dipole antenna, a method for using inductors (e.g., CM inductors) for CM suppression, and a new method of designing TCDA for UWB performance. The TCDA design can provide improvements to beam-scanning performance of the TCDA (e.g., improvements to scan coverage). For example, beam scanning can provide scanning from −60° to +60° in both E and H planes, whereas traditional designs generally cover −45° to +45° or less. Further, as compared with existing UWB arrays such as Vivaldi antenna and horn-based UWB antenna arrays, the proposed TCDA design may be more compact in size (e.g., smaller), low cost (e.g., fewer materials used), lighter weight, and/or manufacturable using standard Printed Circuit Board (PCB) technology. The systems and techniques provide a mass manufacturable and scalable design.

In some aspects, the systems and techniques include a dipole antenna with a first conductor and a second conductor substantially in parallel and oriented along a first plane. For example, the first conductor and the second conductor can be wires. The dipole antenna can include a first conductive arm and a second conductive arm. The first conductive arm can be connected substantially perpendicular to a first end of the first conductor and the second conductive arm can be connected substantially perpendicular to a first end of the second conductor. In such an example, the first conductive arm and the second conductive arm can be oriented along a first plane. In further examples, the first conductive arm is part of the first conductor and the second conductive arm is part of the second conductor.

In some aspects, the first conductor and the second conductor can be connected to a resonator for suppressing or substantially filtering a common mode resonance of the dipole antenna. For example, the resonator can be an inductor. In further aspects, the systems and techniques can include a tapered-slot antenna (e.g., a Vivaldi antenna or other tapered-slot antenna). The tapered-slot antenna can be made of or include a frequency selective surface (FSS) to assist in impedance matching of the dipole antenna or TCDA to a transmission line of a radio frequency signal received by the tapered-slot antenna, dipole antenna, or TCDA. In some examples, the tapered-slot antenna can be divided, sliced, or otherwise portioned into sections (or portions) with the divisions being made in a direction perpendicular to the conductors to reduce interference from the tapered-slot antenna resulting from current flowing through the tapered-slot antenna. The divisions of the tapered-slot antenna can include gaps between adjacent divisions or portions. The systems and techniques can further include methods for determining and constructing the resonator (e.g., the inductor).

### I. Common Mode Resonance

The transition from first generation (1G) to second generation (2G) wireless networks introduced digital cellular networks such as Global System for Mobile Communications (GSM) and Code Division Multiple Access (CDMA), which operated in various bands, generally between 900 MHz and 1.8 GHz. Third generation (3G) technology, generally utilize frequency bands between 1.8 GHz and 2.5 GHz to provide higher data rates, multimedia support like video calls, and faster mobile web browsing experiences. Fourth generation (4G), (e.g., LTE and LTE-Advanced), generally operate in frequency ranges from 1.8 GHz to 2.6 GHz, offering faster data speeds up to 1 gigabit per second (Gbps). Fifth-generation (5G) technology, which generally operates in a range of frequencies, including sub-6 GHz and millimeter-wave bands (24 GHz and above), provides ultra-low latency, with data rates generally exceeding 10 Gbps. The improved speed and latency of 5G technology can support a suite of internet of things (IOT) connectivity options and applications.

As the wireless systems have increased the frequency ranges in which the wireless systems communicate, antennas designed for compatibility with the pre-existing technologies (e.g., 1G-5G) would need to support multiple frequency bands. However, the coexistence of these antennas in an array can cause performance deterioration and power waste due to interactions between electromagnetic and electric waves causing CM resonance.

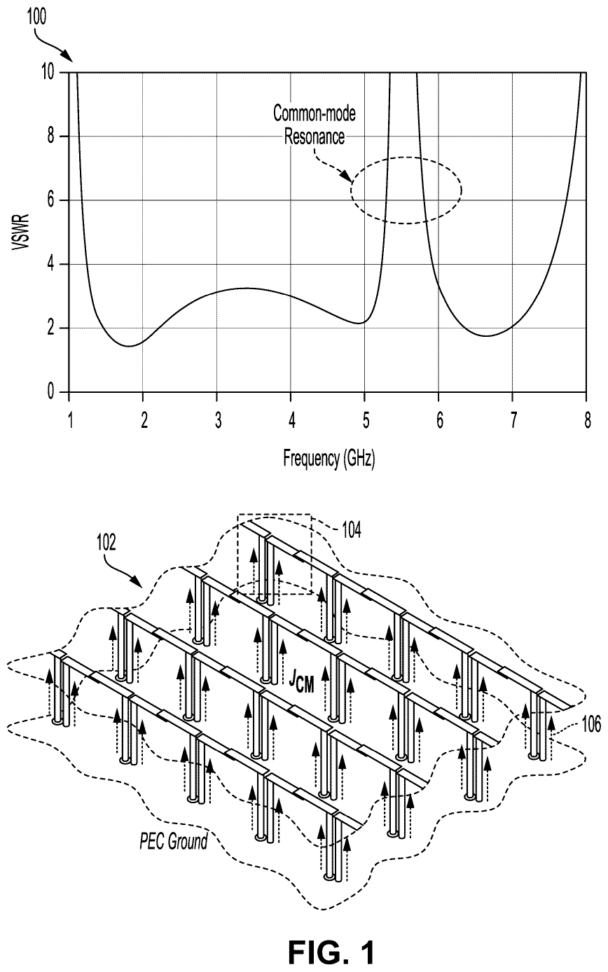

Common mode resonance can occur when current flows along a conductor creating interference distorting an antennas performance. Dipole antennas generally radiate electromagnetic waves (EM) when receiving a differential signal causing current to flow a first direction in a first conductor and an opposite direction in the second conductor. However, the currents on the outer surface of the conductor or other component of the dipole antenna can sometimes be induced by EM waves to flow in the same direction creating undesired radiation (e.g., undesired EM waves). In some instances, the conductors can correspond with a specific resonance frequency causing the antenna to amplify signals at said frequency. FIG. 1 illustrates the amplification of signals of a generic dipole antenna array (e.g., a TCDA) at a common mode frequency. For example, FIG. 1 includes a graph 100 indicating a voltage standing wave ratio (VSWR) of a generic TCDA 102 across different frequencies. As shown in FIG. 1, the amplitude of the signals can increase substantially between 5 GHz and 6 GHz indicating the common mode resonance of the generic TCDA 102. The TCDA includes a plurality of dipole antennas 104. As shown in the generic TCDA 102, the currents 106 (Jcm) are flowing in the same direction through conductors of the TCDA, which can cause interference by radiating EM waves at unintended directions.

### II. Modeling Common Mode Resonance—Cavity Model for TCDA Unit Under CM Resonance

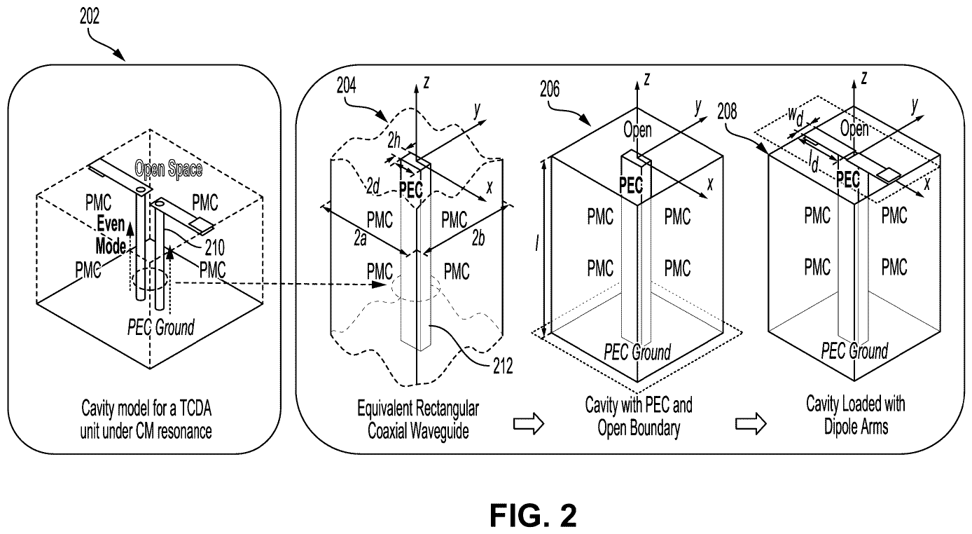

Common mode resonance can be modeled using a cavity model for a single-polarized TCDA unit (e.g., a unit cell). By way of example, FIG. 2 illustrates a set of models (e.g., cavity models) for simulating or modelling a dipole antenna. For example, model 202 illustrates a cavity model for a generic TCDA unit. As shown in model 202, CM currents on the two-wire feed line dominate at CM frequency, meaning electric currents on the vertical feed lines in an infinite array are in-phase as further depicted in currents 106 of FIG. 1. For modeling the TCDA, in-phase currents indicate that side walls of a unit cell can be represented as magnetic walls of the model 202. Analyzing the model 202 can include analyzing orthogonal modes of an equivalent rectangular coaxial waveguide (as illustrated in model 204), identifying resonant modes and field distributions of a cavity resonator formed by applying PEC and open boundary in the direction of wave propagation (as illustrated in model 206), and determining a CM frequency based in part on dipole arms of the dipole antenna (as illustrated in model 208) being modeled.

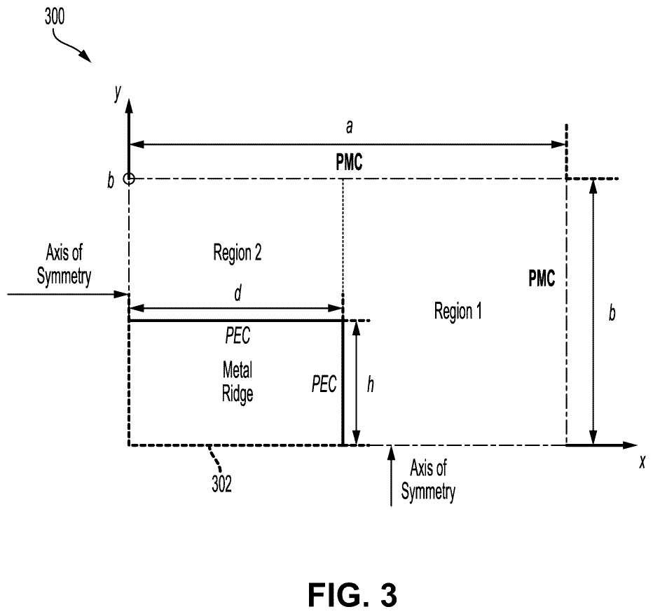

Model 204 illustrates orthogonal modes of the equivalent rectangular coaxial waveguide. Analyzing orthogonal modes can include performing simplifications. For example, the dominating CM frequency supported by an even mode is an even-mode property of the conductors (together referred to as a transmission pair or pair of conductors 210) of the dipole antenna. In even mode, both conductors of the transmission pair share the same electric potential along a propagation direction (e.g., the same voltage along the direction of the propagated currents through the transmission pair). Because there are substantially no electric and magnetic fields between the conductors of the dipole antenna and the distance between the conductors is small, the pair of conductors 210 in model 202 is approximately equivalent to a rectangular metallic strip 212 shown in model 204. Thus, modeling the common mode resonance includes finding orthogonal modes and corresponding cutoff frequencies of an equivalent rectangular coaxial waveguide shown in model 204. Various orthogonal mode analysis techniques can be used to analyze model 204 including single ridge waveguide analysis techniques, and transverse and longitudinal field decomposition in a cylindrical transmission system. In model 204, the structures (e.g., the rectangular metallic strip 212) can be assumed to be uniform and infinitely long in Z direction. The structures can be assumed to be filled with (or to comprise) dielectrics with a real relative permittivity εᵣ and permeability μᵣ. Further description regarding analyzing model 204 is provided in the description of FIG. 3.

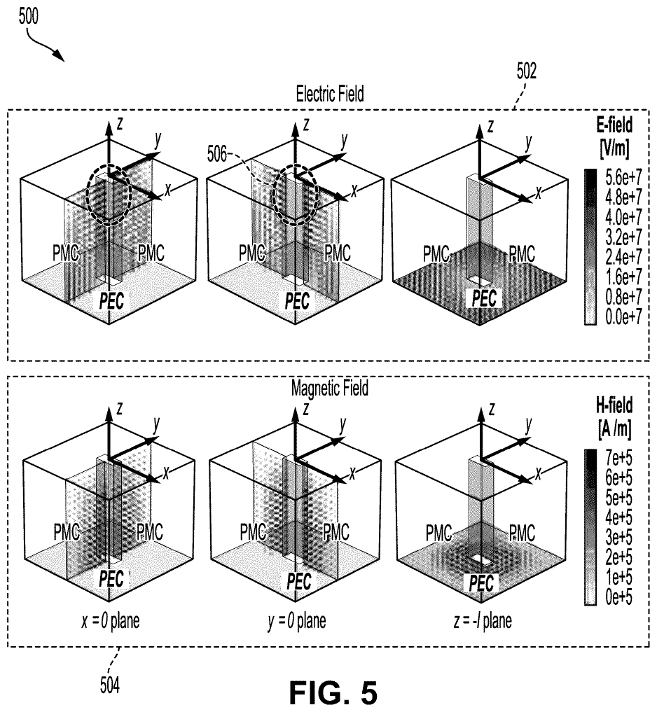

Model 206 illustrates a model for determining a cavity resonator by assuming perfect electrical conductor (PEC) properties of the dipole antenna being modeled and assuming open boundaries in propagating directions of currents and EM waves. Further description of determining the cavity resonator is provided in the description of FIG. 5.

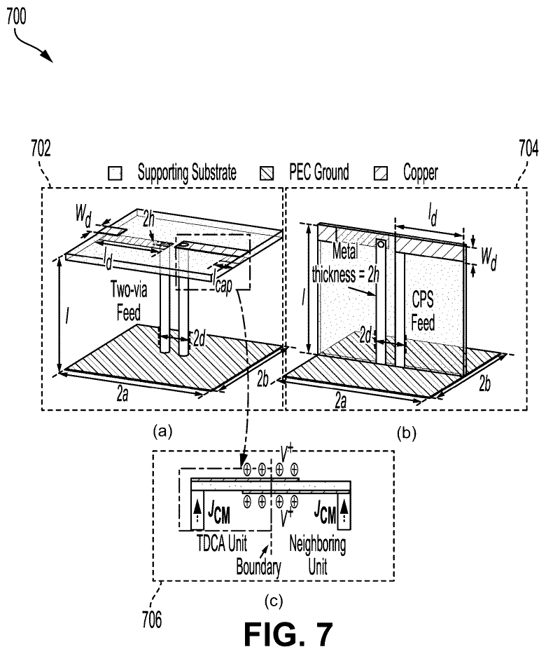

Model 208 illustrates a model for predicting common mode (CM) resonant frequency of a dipole antenna. Model 208 can use the information determined for model 202, model 204, and model 206. Model 208 includes dipole arms (also referred to as conductive arms or conductive dipole arms) added to the cavity model illustrated in model 206. Further description of modeling the dipole arms is provided in the description of FIG. 7. Further, by determining, modelling, or simulating the CM resonant frequency can be used to determine an inductor to be applied to the dipole antenna to suppress CM resonant frequency.

FIG. 3 illustrates a sub-division of a rectangular coaxial waveguide. The sub-division can be a cross-sectional representation 300 of the rectangular metal strip of model 204 described in the description of FIG. 3. The cross-sectional representation 300 can be used to simulate or model electromagnetic forces and electric field through model 204, which can be used to simulate or model the electric field and electromagnetic forces (e.g., electromagnetic waves) through a dipole antenna or TCDA (e.g., a fed dipole antenna or TCDA). Various analysis techniques can be performed using the dimensions and characteristics of the cross-sectional representation 300 to determine electromagnetic forces and electric field such as orthogonal mode analysis.

The cross-sectional representation 300 includes a metal ridge 302. The metal ridge 302 can correspond to the rectangular metal strip of model 204 described in the description of FIG. 2. The metal ridge 302 can be assumed to be a perfect electrical conductor (PEC) and a perfect magnetic conductor (PMC). As a non-limiting example, the dimensions of the metal ridge 302 can be set to d by h dimensions. The electromagnetic forces propagated from the metal ridge 302 and the electric field for the cross-sectional representation 300 can be determined for a distance from the metal ridge 302 associated with PMC walls of the metal ridge 302, the PMC walls having dimensions of a by b. Based on the dimensions of the metal ridge 302 and the PMC walls, the space between the metal ridge 302 and the PMC walls can be divided into two regions (e.g., Region 1 and Region 2).

By way of example, the cross-sectional representation 300 can be used to simulate, model, or determine (e.g., by using a computing device or component thereof) the electromagnetic waves and electric field of the metal ridge 302 using Helmholtz equations. For example, Helmholtz equations can be used at a z-cross section subject to the electromagnetic waves propagating from the metal ridge 302 and the electric field. In such an example, boundary conditions on PEC walls (e.g., the walls of the metal ridge 302) can be set to E_{z}=0 or ∂H_{z}/∂n=0. In such an example, the PMC walls can be set to H_{z}32 0 or ∂E_{z}/∂n=0. Even mode dominants in an unbalanced TCDA at common mode frequency, at axes of symmetry of the cross-sectional representation 300, can exhibit the same or equivalent properties as PMC (∂E_{z}/∂n=0). Additionally, because the cross section has irregular shape, Region 1 and Region 2 are different dimensions and have different field distributions (e.g., different electric field distributions).

### III. Modeling Common Mode Resonance—Orthogonal Mode Analysis of the Proposed Rectangular Coaxial Waveguide

The following equations can represent the dimensions and field distributions of Region 1 and Region 2.

$$Region 1 : d \leq x \leq a , 0 \leq y \leq b$$

$$Region 2 : 0 \leq x \leq d , s \leq y \leq b$$

Region 1 and Region 2 share the same electric field distribution along line x=d, s<y=d of the cross-sectional representation 300. The transverse magnetic (TM) mode for each of the regions is determined to model or simulate the field distribution of each respective region. For example, the TM mode of Region 1 can be represented as:

$${∇}_{t}^{2} {E}_{z 1} + {k}_{c}^{2} {E}_{z 1} = 0$$

$$\frac{\partial {E}_{z 1}}{\partial n} {\vert}_{d \leq x \leq a , y = 0} = 0$$

$$\frac{\partial {E}_{z 1}}{\partial n} {\vert}_{d \leq x \leq a , y = b} = 0$$

$$\frac{\partial {E}_{z 1}}{\partial n} {\vert}_{x = a , 0 ≦ y \leq b} = 0$$

In such an example, subscript 1 can represent Region 1. Coefficient k_{c} represents a propagation constant of Region 1. In a lossless medium (of which Region 1 and Region 2 can be assumed to be), propagation coefficient k_{c} can be defined as k_{c}=k²-β², where k=ω\sqrt{με} is the wave number and β is phase constant. The general solution to the above equation can be represented as:

$${E}_{z 1} = ( {A}_{11} {e}^{- {jk}_{x 1} x} + {A}_{21} {e}^{- {jk}_{x 1} x} ) \cdot ( {B}_{11} {e}^{- {jk}_{y 1} y} + {B}_{21} {e}^{- {jk}_{y 1} y} ) {C}_{1} {e}^{- j βz}$$

In such an example, A₁₁, A₂₁, B₁₁, B₂₁, C₁, kₓ₁, and kₓ₂ are unknown factors which dependent on boundary conditions of Region 1 and Region 2. For example, at boundary y=0, d≤x≤a, ∂E_{z1}/∂y=0, the following equation can represent the change in electric field:

$$\frac{\partial {E}_{z 1}}{\partial y} = ( {A}_{11} {e}^{- {jk}_{x 1} x} + {A}_{21} {e}^{{jk}_{x 1} x} ) \cdot ( - {jk}_{y 1} \cdot {B}_{11} {e}^{- {jk}_{y 1} y} + {jk}_{y 1} \cdot {B}_{21} {e}^{{jk}_{y 1} y} ) {C}_{1} {e}^{- j βz} = 0.$$

Simplifying the equation above in terms of y=0, can result in: B₁₁=B₂₁=B₁.

The cross-sectional representation 300 can be used to determine electric fields at various boundaries of Region 1 and Region 2. For example, Region 1 and Region 2 boundary y=b, d≤x≤a, ∂E_{z1}/∂y=0, can be represented as

$$\frac{\partial {E}_{z 1}}{\partial y} = ( {A}_{11} {e}^{- {jk}_{x 1} x} + {A}_{21} {e}^{{jk}_{x 1} x} ) \cdot ( - {jk}_{y 1} \cdot {B}_{11} {e}^{- {jk}_{y 1} b} + {jk}_{y 1} \cdot {B}_{21} {e}^{{jk}_{y 1} b} ) {C}_{1} {e}^{- j βz} = 0$$

which can be simplified to

$${k}_{y 1} = \frac{n π}{b}$$

wherein (n=1, 2, 3 . . . ). In such an example, n can represent the number of half wavelengths (λ/2) in a y direction.

The Region 1 electric field at boundaries x=a, 0≤y≤b, can be represented by the following equation:

$$\frac{\partial {E}_{z 1}}{\partial x} = ( - {jk}_{x 1} \cdot {A}_{11} {e}^{- {jk}_{x 1} x} + {jk}_{x 1} \cdot {A}_{21} {e}^{{jk}_{x 1} x} ) \cdot ( {B}_{11} {e}^{- {jk}_{y 1} y} + {B}_{21} {e}^{{jk}_{y 1} y} ) {C}_{1} {e}^{- j βz} .$$

A substitution of x in the previous equation can be used to satisfy the previously described condition of ∂E_{z1}/∂x=0, resulting in the following equation:

$$\frac{\partial {E}_{z 1}}{\partial x} = ( - {jk}_{x 1} \cdot {A}_{11} {e}^{- {jk}_{x 1} ( x - a )} + {jk}_{x 1} \cdot {A}_{21} {e}^{{jk}_{x 1} ( x - a )} ) \cdot ( {B}_{11} {e}^{- {jk}_{y 1} y} + {B}_{21} {e}^{{jk}_{y 1} y} ) {C}_{1} {e}^{- j βz} = 0.$$

The previous equation can be simplified in terms of x=a, to produce A₁₁=A₂₁=A₁.

The simplified equations B₁₁=B₂₁=B₁, A₁₁=A₂₁=A₁, and

$${E}_{z 1} = ( {A}_{11} {e}^{- {jk}_{x 1} x} + {A}_{21} {e}^{- {jk}_{x 1} x} ) \cdot ( {B}_{11} {e}^{- {jk}_{y 1} y} + {B}_{21} {e}^{- {jk}_{y 1} y} ) {C}_{1} {e}^{- j β z}$$

can be rewritten as:

$${E}_{z 1} = [ {A}_{1} {e}^{{jk}_{x 1} ( x - a )} + {A}_{1} {e}^{- {jk}_{x 1} ( x - a )} ] \cdot 2 {B}_{1} cos ( {k}_{y 1} y ) \cdot {C}_{1} {e}^{- j βz} .$$

Propagation coefficient k_{c} has a relationship of

$${k}_{c}^{2} = {k}_{x 1}^{2} + {k}_{y 1}^{2}$$

with tangential propagation coefficients kₓ₁ and k_{y1}, resulting in the following equation:

$${jk}_{x 1} = \sqrt{- {k}_{c}^{2} + {k}_{y 1}^{2}} = \sqrt{- {k}_{c}^{2} = {( \frac{n π}{b} )}^{2}}$$

E_{z1} can then be derived to be

$${E}_{z 1} = {\sum }_{n = 0 , 1 , 2 , 3 …ψ1n} \cdot cosh [ {w}_{1 n} ( \frac{x}{a} - 1 ) ] \cdot cos ( \frac{n π y}{b} ) \cdot {e}^{j β}$$

where

$${ψ}_{1 n} = 4 {A}_{1} {B}_{1} {C}_{1} and {w}_{1 n} = \sqrt{- {k}_{c}^{2} {a}^{2} + {( \frac{n π a}{b} )}^{2}} .$$

The following equations can be used in determining an even TM mode of Region 2:

$$\{ \begin{matrix}{▽}_{t}^{2} {E}_{z 2} + {k}_{c}^{2} {E}_{z 2} = 0 \\ {\frac{\partial {E}_{z 2}}{\partial n} \vert}_{0 \leq x \leq d , y = b} = 0 \\ {{E}_{z 2} \vert}_{0 \leq x \leq d , y = h} = 0 \\ {\frac{\partial {E}_{z 2}}{\partial n} \vert}_{x = 0 , s \leq y \leq b} = 0\end{matrix} ,$$

In the previous equation, subscript 2 can represent Region 2. The following method of variable separation and boundary conditions, can provide a general solution can be to simulate, modeling, or determining the electric field of Region 2 resulting in the equation:

$${E}_{z 2} = ( {A}_{12} {e}^{- {jk}_{x 2} x} + {A}_{22} {e}^{j {k}_{x 2} x} ) \cdot ( {B}_{12} {e}^{- {jk}_{y 2} y} + {B}_{22} {e}^{- {jk}_{y 2} y} ) {C}_{1} {e}^{- j β z} .$$

The electric field of Region 2 at boundary y=b, 0≤x≤d, can be determined using

$$\frac{\partial {E}_{z 2}}{\partial y} = ( {A}_{12} {e}^{- {jk}_{x 2} x} + {A}_{22} {e}^{j {k}_{x 2} x} ) \cdot ( - {jk}_{y 2} \cdot {B}_{12} {e}^{- {jk}_{y 2} y} + {jk}_{y 2} \cdot {B}_{22} {e}^{- {jk}_{y 2} y} ) {C}_{2} {e}^{- j β z} .$$

Further, because ∂E_{z2}/∂y is assumed to equal 0, a substitution of y in the previous equation can simplify the equation to:

$$\frac{\partial {E}_{z 2}}{\partial y} = ( {A}_{12} {e}^{- {jk}_{x 2} x} + {A}_{22} {e}^{j {k}_{x 2} x} ) \cdot ( - {jk}_{y 2} \cdot {B}_{12} {e}^{- {jk}_{y 2} ( y - b )} + {jk}_{y 2} \cdot {B}_{22} {e}^{{jk}_{y 2} ( y - b )} ) .$$

When y=b, the equation can be simplified to B₁₂=B₂₂=B₂.

The propagation coefficient of Region 2 can be determined at boundary y=s, 0≤x≤d, E_{z2}=0 can be derived using:

$$( {A}_{12} {e}^{- {jk}_{x 2} x} + {A}_{22} {e}^{j {k}_{x 2} x} ) \cdot ( {B}_{12} {e}^{- {jk}_{y 2} ( s - b )} + {B}_{22} {e}^{j {k}_{y 2} ( s - b )} ) {C}_{2} {e}^{- j β z} = 0$$

In such an example,

$${k}_{y 2} = \frac{( 2 n - 1 ) π}{2 ( b - s )}$$

where (n=1, 2, 3 . . . ). Further, according to

$${k}_{c}^{2} = {k}_{x 2}^{2} + {k}_{y 2}^{2} ,$$

tangential propagation coefficients kₓ₂ can be determined to be:

$${jk}_{x 2} \vert \begin{matrix}= \sqrt{- {k}_{c}^{2} + {k}_{y 2}^{2}} \\ \sqrt{- {k}_{c}^{2} + {[ \frac{( 2 n - 1 ) π}{2 ( b - s )} ]}^{2}}\end{matrix} where ( n = 1 , 2 , 3 … ) .$$

At boundary x=0, h≤y≤d, the electric field of Region 2 can be determined using the following equation:

$$\frac{\partial {E}_{z 2}}{\partial y} = ( - {jk}_{x 2} \cdot {A}_{12} {e}^{- {jk}_{x 2} x} + {jk}_{x 2} \cdot {A}_{22} {e}^{j {k}_{x 2} x} ) ( {B}_{12} {e}^{- {jk}_{y 2} ( y - b )} + {B}_{22} {e}^{{jk}_{y 2} ( y - b )} ) {C}_{2} {e}^{- j β z} = 0.$$

The equation can be simplified in terms of x=0 resulting in A₁₂=A₂₂=A₂.

Based on the previously described equations, E_{z2} can be represented as:

$${E}_{z 2} = {Σ}_{n = 1 , 2 , 3 …} {ψ}_{2 n} \cdot cosh [ \frac{{w}_{2 n} x}{a} ] \cdot cos [ \frac{( 2 n + 1 ) π}{2 ( b - h )} ( y - b ) ] \cdot {e}^{- j β z}$$

where:

$$\{ \begin{matrix}{ψ}_{2 n} = 4 {A}_{2} {B}_{2} {C}_{2} \\ {w}_{2 n} = \sqrt{- {k}_{c}^{2} {a}^{2} + {[ \frac{( 2 n - 1 ) a π}{2 ( b - h )} ]}^{2}} .\end{matrix}$$

On the boundary between Region 1 and Region 2, the components of field vectors E and H are continuous. For example, where E_{z1}=E_{z2}, along 0≤y≤b, the following equations can be determined:

$${Σ}_{m = 1 , 2 , 3 …} {ψ}_{2 m} \cdot cosh [ \frac{{w}_{2 n} d}{a} ] \cdot cos [ \frac{( 2 n + 1 ) π}{2 ( b - h )} ( y - b ) ] \cdot {e}^{- j β z} = \{ \begin{matrix}0 , & 0 \leq y \leq s \\ {Σ}_{m = 1 , 2 , 3 …} {ψ}_{2 m} \cdot cosh [ \frac{{w}_{2 m} d}{a} ] \cdot cos [ \frac{( 2 m + 1 ) π}{2 ( b - h )} ( y - b ) ] \cdot {e}^{- j β z} , & s \leq y \leq b\end{matrix}$$

The previous equation can be rewritten after multiplying by cos[rπ(y−b)] and integrating from 0 to b. In such an example, when m=r the left-hand side of the above equation has non-zero value. The previous equation can be rewritten or simplified to:

$$\frac{b}{2} \cdot {ψ}_{1 r} \cdot cosh [ {w}_{2 r} ( \frac{d}{a} - 1 ) ] \cdot {Δ}_{r} = {Σ}_{m = 1 , 2 , 3 …} {ψ}_{2 m} \cdot cosh [ \frac{{w}_{2 m} d}{a} ] \cdot {C}_{rm} where$$

$${Δ}_{r} = \{ \begin{matrix}1 & , r = 0 \\ 2 & , r \neq 0\end{matrix} and {C}_{rm} {\int }_{h}^{b} cos [ \frac{( 2 m - 1 ) π}{2 ( b - h )} ] \cdot ( y - b ) \cdot cos [ \frac{r π}{b} \cdot ( y - b ) ] dy .$$

In another example of a shared boundary between Region 1 and Region 2, H_{y1}=H_{y2} can be derived according to Maxwell equations to produce:

$${\sum }_{m = 1 , 2 , 3 …} {ψ}_{1 m} \cdot {w}_{1 m} \cdot sinh [ {w}_{1 m} ( \frac{x}{a} - 1 ) ] \cdot cos [ \frac{m π}{b} ( y - b ) ] \cdot {e}^{- j β z} = {\sum }_{m = 1 , 2 , 3 …} {ψ}_{2 m} \cdot {w}_{2 m} \cdot sinh ( \frac{{w}_{2 m} x}{a} ) \cdot cos [ \frac{( 2 m - 1 ) π}{2 ( b - h )} ( y - b ) ] \cdot {e}^{j β z}$$

In another example, the previous equation can be rewritten by multiplying the equation by cos[(2n−1)π·(y−b)/(2b−2h)] and integrating from h to b. When n=m the right-hand side of the above equation has non-zero value. The previous equation can be rewritten as:

$${\sum }_{n = 1 , 2 , 3 …} {ψ}_{1 n} \cdot {w}_{1 n} \cdot sinh [ {w}_{1 n} ( \frac{d}{a} - 1 ) ] \cdot {C}_{n m} = \frac{b - s}{2} \cdot {ψ}_{2 m} \cdot {w}_{2 m} \cdot sinh [ \frac{{w}_{2 m} d}{a} ) ] .$$

The previous equation can be simplified substituting ψ₂ₘ to derive:

$${\sum }_{n = 1 , 2 , 3 …} {ψ}_{1 n} \cdot sinh [ {w}_{1 n} ( \frac{d}{a} - 1 ) ] \cdot {E}_{r n} = 0 where {E}_{r n} = \frac{4}{( b - h ) b} \cdot \frac{{w}_{1 n}}{{Δ}_{n}} \cdot [ {\sum }_{m - 1}^{+ ∞} \frac{{C}_{n m} {C}_{r m}}{{w}_{2 m}} \cdot coth ( \frac{{w}_{2 m} d}{a} ) ] - {σ}_{r n} \cdot coth [ \frac{d}{a} - 1 ] and {σ}_{r n} = \{ \begin{matrix}1 & , n = r \\ 0 & , n \neq r\end{matrix} .$$

To ensure function the previous equations have non-zero solutions, Eᵣₙ is a non-singular matrix, where Det[Eᵣₙ]=0.

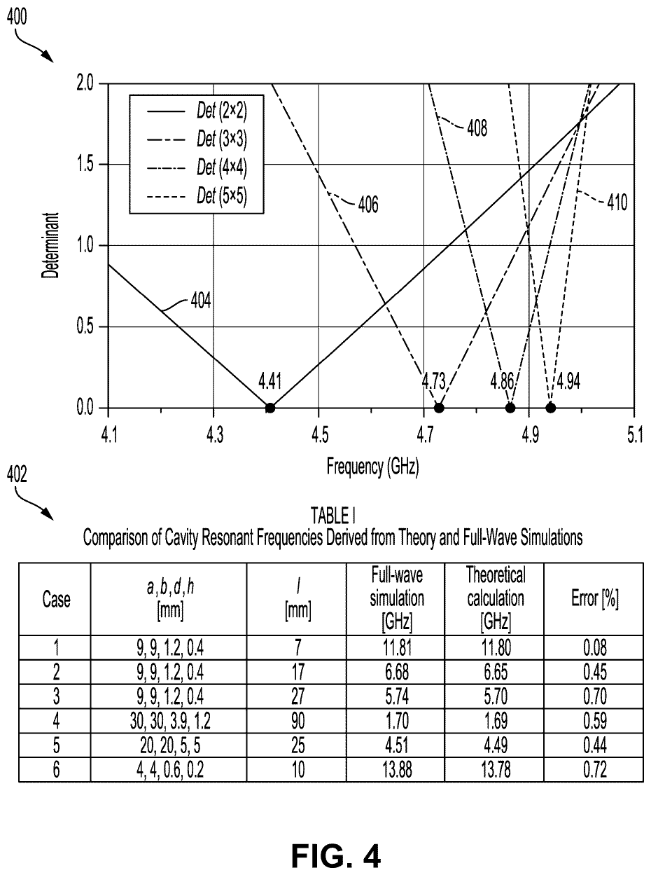

FIG. 4 is a plot diagram 400 of an n by n determinant of matrix Eᵣₙ (e.g., the Eᵣₙ derived in the description of FIG. 3) over frequencies 4.1 GHz to 5.1 GHz. For example, the plot diagram 400 includes a 2×2 determinant plot 404, a 3×3 determinant plot 406, a 4×4 determinant plot 408, and a 5×5 determinant plot 410. FIG. 4 includes a table 402 of cavity resonant frequencies derived from the theory and full-wave simulations which the plot diagram 400 illustrates.

Eᵣₙ can be an infinite-dimensional square matrix. An approximation can be used to produce a cut-off wave number of Eᵣₙ. Parameters a, b, d, and h (shown in the table 402 and corresponding to the dimensions of the cross-sectional representation 300 of FIG. 3) included in the expression of Eᵣₙ (e.g., the dimensions are present in the previously derived equation representing the electrical field of the cross-sectional representation 300—Eᵣₙ). As an example, shown also in the table 402, a, b, d, and h can be defined as: a=b=9 mm, d=1.2 mm and h=0.4 mm. The aforementioned example of a resulting determinant representation of an electric field is plotted in the plot diagram 400 from 2×2 to 5×5 determinant representations. For example, the The cutoff frequency for a lowest order transverse magnetic TM mode (e.g., TM₁₁ mode), is the point where the value of determinant is zero.

As illustrated in the table 402, for 4.91 GHz frequencies derived from full-wave simulations, a 5×5 determinant provides the most closed result (as illustrated in the plot diagram 400). In some examples, a lower order determinant representation can be used to reduce computing resources for determining the electrical field. For example, a 2×2 determinant representation can be used instead of a 5×5 determinant representation to reduce the number calculations to simulate, model, or determine the electrical field. In practice, if a less precise result is acceptable, lower order of the determinant can be chosen to reduce calculation amount. Generally, lower order determinants (e.g., 2×2) are more prone to error than higher order determinants (e.g., 5×5).

### IV. Modeling Common Mode Resonance—Cavity Mode Analysis

The orthogonal modes of the rectangular coaxial waveguide (determined in the description of FIG. 3) can be used to simulate, model, or determine a cavity resonator. The cavity resonator can be determined by applying perfect electrical conductor (PEC) properties to a cavity model representation of a dipole antenna (such as model 206 of FIG. 2) and using the orthogonal modes determined in the description of FIG. 3.

For example, a z-component of dipole antenna (the z-component being in the direction of a conductor of the dipole antenna such as the z-component depicted in model 206 of FIG. 2) can have a transverse electric field in the form of being modeled the transverse electric field has the form of Eₜ(x, y, z)=Eₜ(x, y)(A⁺e^{-jβz}+A⁻e^{+jβz}). The cavity of the cavity model can be modeled by forming a coaxial waveguide which is short-circuited at one end (e.g., z=−l) and open-circuited at another end (e.g., (z=0), as represented by the equation:

$$\{ \begin{matrix}{E}_{t} {\vert}_{z = - 1} = 0 \\ \frac{\partial {E}_{t}}{\partial z} {\vert}_{z = 0} = 0\end{matrix} where \partial {E}_{t} / \partial z = 0 at z = 0 means {A}^{+} = - {A}^{-} .$$

In such an example, Eₜ=0 at z=−l and Eₜ(x, y, −l)=Eₜ(x, y) A⁺(e^{jβl}+e^{jβl})=0.

Based on the previous equation,

$$β = \frac{( 2 p - 1 )}{2 l} π$$

can be determined. In such an example, β can represent a phase coefficient in z direction and p can represent a number of half wavelengths (λ/2) in z direction. The dominant resonant mode of a cavity resonator can be based on the TM₁₁₁ mode to propagate. The wave number for cavity at p=1 can be written as

$${k}_{111} = \sqrt{{k}_{c}^{2} + {β}^{2}} = \sqrt{{k}_{c}^{2} + {( \frac{π}{2 l} )}^{2}} .$$

The resonance frequency of the TM₁₁₁ mode can be

$${f}_{111} = \frac{c}{2 π \sqrt{{ε}_{r} {μ}_{r}}} \sqrt{{k}_{c}^{2} + {( \frac{π}{2 l} )}^{2}} .$$

FIG. 5 illustrates a first block diagram 502 of an example electric field distribution of a cavity model (e.g., the model 206) plotted across selected planes of the cavity model and a second block diagram 504 of an example magnetic field distribution plotted across selected planes of the cavity model. For example, the first block diagram 502 illustrates example electric field distributions across x=0, y=0, and z=−l planes. The second block diagram 504 illustrates example magnetic field distributions across x=0, y=0, z=−l planes. In the first block diagram 502, the electric field increases in strength closer to the perfect electric conductor ground and closer to the central metal as depicted in dashed circle 506.

Vertical electric field distributions of the first block diagram 502 near a perfect electric conductor (PEC) ground has maxima between elements. In the first block diagram 502, a horizontal electric field is located near a top of a feed line at CM resonance. In the second block diagram 504, the magnetic field distribution includes horizontal components and forms a circular loop around a central metallic strip 508. The electric field and magnetic field distributions of the first block diagram 502 and the second block diagram 504 (e.g., of a cavity model such as the model 206).

### V. Modeling Common Mode Resonance—Predicting Common Mode Resonant Frequency

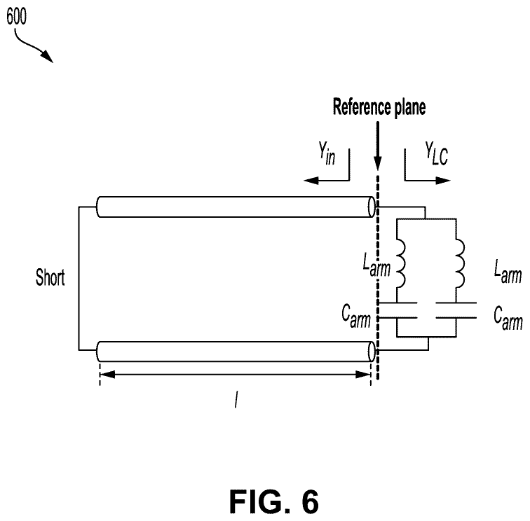

Modeling the common mode (CM) resonant frequency can include adding dipole arms to a cavity model (e.g., the model 206 to generate the model 208 of FIG. 2). A dipole arm can be represented as a series inductor-conductor (LC) resonator with inductor Lₐᵣₘ and capacitor Cₐᵣₘ, and a coaxial line resonator loaded with inductors and capacitors can be modelled. For example, FIG. 6 illustrates an example equivalent circuit 600 of a dipole antenna. The equivalent circuit 600 can be constructed (e.g., physically or simulated) to determine CM resonant frequency of a dipole antenna to be modelled.

The equivalent circuit 600 includes a short (e.g., a short-circuit transmission line of length l left of a reference plane. The input admittance Yᵢₙ of the equivalent circuit 600 through the transmission line can be written as:

$${Y}_{i n} = - j \frac{1}{{Z}_{c}} cot β l = - j {B}_{in} ,$$

where

$$β = \sqrt{{k}^{2} - {k}_{c}^{2}} = \sqrt{{( \frac{ω}{v} )}^{2} - {k}_{c}^{2}} and {Z}_{c} = \frac{βη}{k} .$$

In some examples, the transmission line is set to the length of conductors (e.g., transmission lines) of the dipole antenna to be simulated, modeled, or determined.

Free space intrinsic impedance is represented by η and voltage is v=1/\sqrt{εμ}. A parallel resonant circuit of the dipole arms is represented at the right side of the reference plane. In such an example, each dipole arm can be regarded as a series LC resonator with inductor Lₐᵣₘ and capacitor Cₐᵣₘ. Input admittance Y_{LC} can be written as

$${Y}_{L C} = j {B}_{L C} = \frac{2}{\frac{1}{j ω {c}_{a r m}} + j ω {L}_{a r m}} .$$

At resonant frequency, parallel admittance at the reference plane can be 0. A condition for determining CM resonant frequency can be B_{LC}−Bᵢₙ=0.

FIG. 7 is a block diagram 700 illustrating a dipole antenna of a tightly-coupled dipole antenna (TCDA) array. The block diagram 700 includes a first dipole model 702 of a dipole antenna with a two-via feed (e.g., two conductors or transmission lines substantially in parallel), a second dipole model 704 of a dipole antenna where the two conductors of the dipole antenna are coplanar strip line (CPS) transmission line representations, and a current and charge model 706 at an overlapped region of dipole arms of two dipole antennas of a TCDA. The first dipole model 702, the second dipole model 704, and the current and charge model 706 can be used to determine common mode resonant frequency of the dipole antenna to be modeled.

The first dipole model 702 and the second dipole model 704. The first dipole model 702 and the second dipole model 704 include a similar radiation structure (overlapped dipoles arms) but different feeding structures. For example, the first dipole model 702 includes a two-via feed and the second dipole model 704 includes a coplanar strip line (CPS) feed. The different feeding structure used in the dipole models can be selected based on the dipole antenna to be simulated or modeled (e.g., a dipole with CPS feed can be modeled using the second dipole model 704 and a dipole antenna with a two-via feed can be modeled using the first dipole model 702).

Inductor Lₐᵣₘ and capacitor Cₐᵣₘ of dipole arms (e.g., dipole arms of the first dipole model 702 and the second dipole model 704) can be evaluated using formulas for long metal strips and parallel-plate capacitors such as:

$${L}_{a r m} = \frac{{μ}_{0} ( {l}_{d} + {l}_{cap} )}{2 π} \cdot [ ln \frac{2 ( {l}_{d} + {l}_{cap} )}{{w}_{cap}} - 0.2 \; 235 ln \frac{{w}_{cap}}{( {l}_{d} + {l}_{cap} )} + \frac{1}{2} ] and {C}_{a r m} = {ε}_{0} {ε}_{s} \frac{{w}_{cap} {l}_{cap}}{{l}_{s}} .$$

The aforementioned Lₐᵣₘ and Cₐᵣₘ equations can be used to determine B_{LC} (e.g., the susceptance of the dipole arms) and Bᵢₙ cam represent the susceptance of the conductors of the dipole antennas (e.g., the transmission lines such as the two-via feed and the CPS feed).

The current and charge model 706 of FIG. 7 illustrates currents on feedlines (e.g., the transmission lines) of the dipole antennas of FIG. 7. When the dipole antenna is in common mode (e.g., at common mode resonant frequency) the currents on feed lines (e.g., the conductors of the dipole antenna) are in-phase resulting in similar (e.g., substantially equivalent) electric potential of dipole arms instead of opposite electric potential on neighboring dipole arms. The current and charge model 706 illustrates overlapped dipole arms to form parallel plates. When charges with the same sign on the parallel plates can cause overlapped region to perform differently (e.g., to have a different electric field, magnetic field, current, and charge) from a parallel plate capacitor. The following equation can represent capacitance of overlapping dipole arms:

$${C}_{a r m} = \frac{1}{{L}_{a r m} {ω}_{d}^{2}} = \frac{1}{{{L}_{a r m} ( \frac{π}{2 a \cdot \sqrt{εμ}} )}^{2}}$$

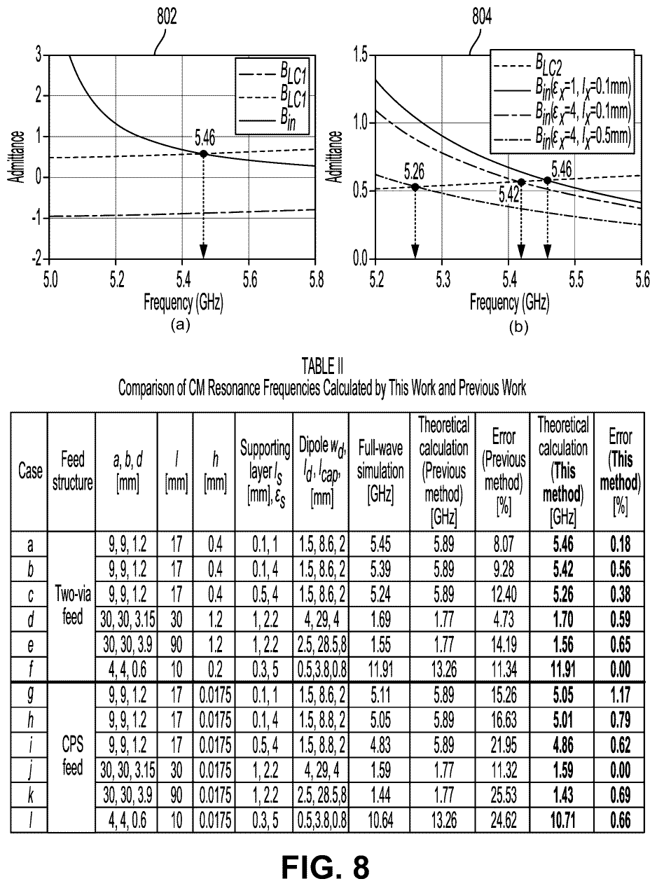

FIG. 8 is a block diagram including a first line graph 802 illustrating admittance (in particular susceptance B_{LC} and Bᵢₙ) of parts of dipole antenna (e.g., the dipole arms and conductors of a circuit representation of a dipole antenna such as FIG. 6) over different frequencies and a second line graph 804 illustrating admittance of a dipole antenna with various dielectric constants εₛ and thickness lₛ of a supporting layer (e.g., substrate). Intersections between the admittance B_{LC} and Bᵢₙ can indicate the common mode resonance of the circuit representation of the dipole antenna, and therefore also the dipole antenna. The second line graph 804 illustrates different substrates used as supporting layers and the effect of the supporting layer on a common mode resonance of the dipole antenna. The first line graph 802 and the second line graph 802 illustrate how to determine common mode frequency from admittances of portions of the dipole antenna (e.g., at the intersection).

Table II of FIG. 8 illustrates Bᵢₙ versus frequency over different examples of substrates or substrate thickness. Table II illustrates examples of substrate and dipole antenna design dimensions and corresponding CM resonance frequencies. Table II can be used to determine dipole antenna design dimensions and substrate dimensions for various common mode resonance frequencies.

### VI. Method of Suppressing Common Mode Resonance

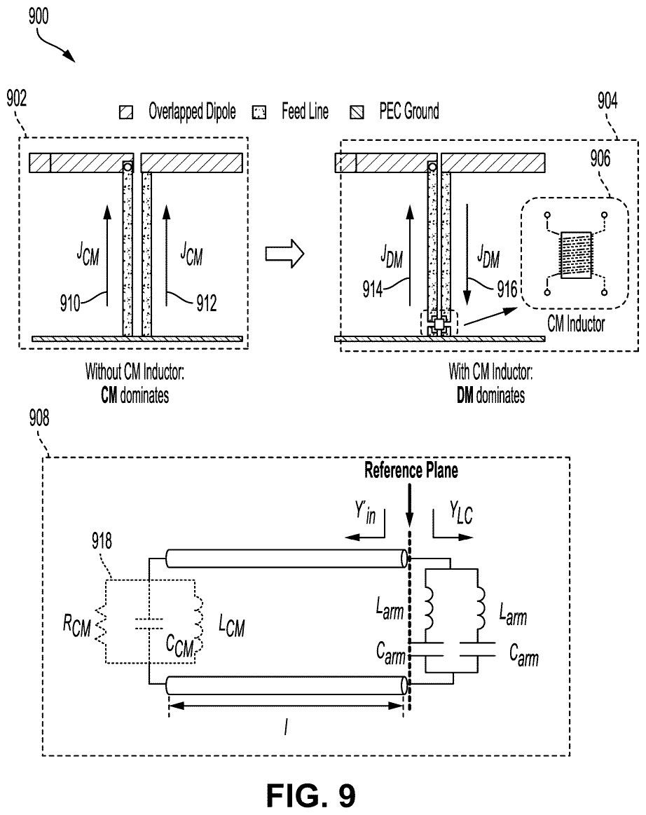

FIG. 9 illustrates a first dipole model 902 in common mode, a second dipole model 904 with a common mode inductor 906 in differential mode (DM), and an equivalent circuit representation 908 of the second dipole model 904 and the common mode inductor 906. For example, the first dipole model 902 is in common mode (CM) as illustrated by common mode currents 910 and 912 traveling in a same direction through conductors of the first dipole model 902. The second dipole model 904 includes the common mode inductor 906 for suppressing the common mode frequency. The second dipole model 904 is in differential mode, as shown by the differential mode currents 914 and 916 traveling in different directions.

The equivalent circuit representation 908 can be the equivalent circuit 600 of FIG. 6 with a common mode inductor 918 (e.g., the common mode inductor 906 of the second dipole model 904) added to the left side of the reference plane (e.g., representing the common mode inductor applied across conductors of the dipole antenna).

The common mode inductor 906, 918 can include two windings and a magnetic core. The common mode inductor can operate as an inductor with inductance, resistance, and an interwinding capacitance under common mode currents in part caused by magnetic fluxes propagated by the two windings. For differential mode (DM) current, the magnetic fluxes can cancel the other out. For common mode, the common mode currents are suppressed by the magnetic fluxes.

The common mode inductor 906, 918 can be determined, modeled, or simulated based on the determined common mode resonance of the dipole antenna represented in analysis models 202, 204, 206, and 208 from FIG. 2. The input admittance

$${Y}_{i n}^{′}$$

of the transmission line of the dipole antenna (e.g., the conductors of the antenna) can be represented as:

$${Y}_{i n}^{′} = {Z}_{c} \frac{{Z}_{C M} + j {Z}_{c} tan β l}{{Z}_{c} + j {Z}_{C M} tan β l} = {G}_{C M} - j {B}_{C M}$$

where Z_{CM} is an impedance of the common mode inductor. The impedance can be represented as:

$${Z}_{C M} = {( \frac{1}{{R}_{C M}} + j ω {C}_{C M} + \frac{1}{j ω {L}_{C M}} )}^{- 1}$$

In FIG. 9, the resonant condition is still parallel admittance equals to 0 at reference plane T and therefore the susceptance at common mode resonance of the dipole antenna can be represented as: B_{LC}−B_{CM}=0. In such an example, because the common mode frequency occurs when the B_{CM} can be determined based on determining B_{LC}, as described in the description of FIGS. 2-7.

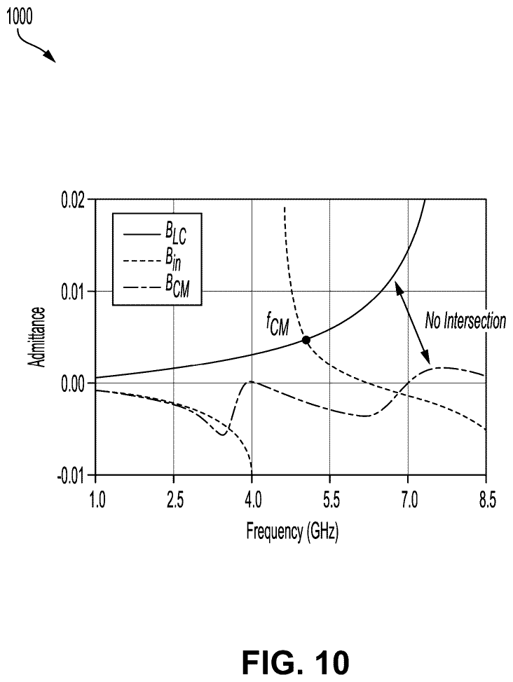

FIG. 10 is a line graph 1000 of a function representing admittance of a common mode inductor (e.g., the common mode inductor 906, 918 of FIG. 9) applied to a dipole antenna by plotting a current distribution at CM frequency on a feedline before and after applying the CM inductor to conductors of the dipole antenna. As illustrated in Table II of FIG. 8, case “a” of dipole antennas illustrates a working frequency lower than 8.33 GHZ. In such an example, a CM inductor for dipole antennas with a working frequency below 10 GHz can be selected and applied to the dipole antenna. In such an example, the CM inductor can have an inductance of 25 nano-Henrys (nH), an interwinding capacitance of 0.2 pico-Farads (pF) and resistance of 500Ω.

The line graph 1000 includes B_{LC}, Bᵢₙ and B_{CM} versus frequency. B_{LC} and Binhas an intersection, namely the original CM frequency, but B_{LC} and B_{CM} do not perform any intersection in the whole frequency band indicating the CM resonance is suppressed by applying the CM inductor to the dipole antenna.

### VII. Tightly Coupled Dipole Antenna (TCDA) with Ultra-Wideband Performance and Wide-Angle Scanning

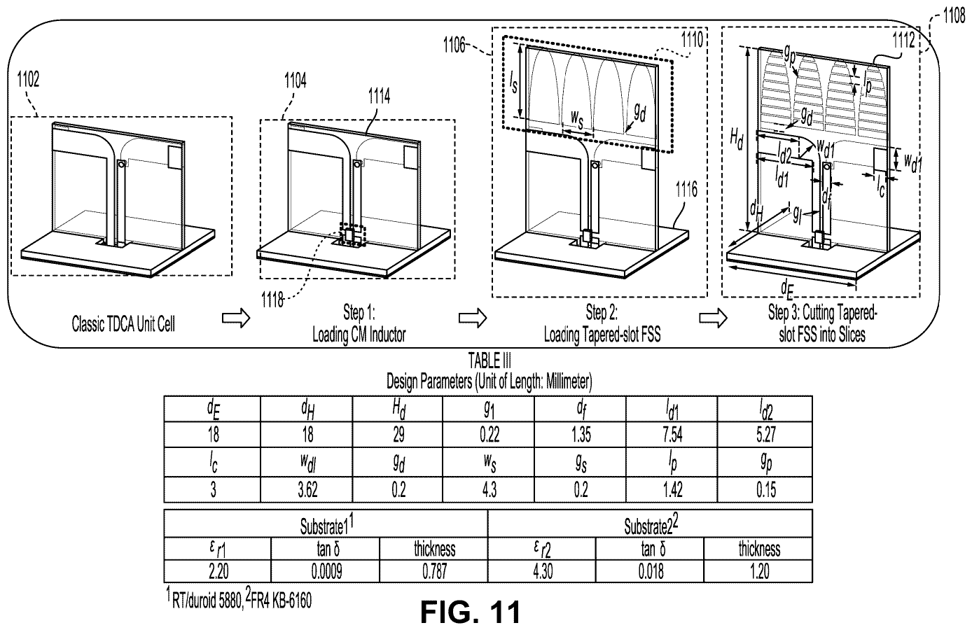

A tapered-slot antenna can be applied to a dipole antenna (e.g., a dipole antenna including a CM inductor for suppressing CM resonance). FIG. 11 is a block diagram illustrating a process for suppressing CM resonance of a dipole antenna and applying tapered slot antenna to the dipole antenna. For example, the process can include constructing or providing a dipole antenna, such as the dipole antenna illustrated in model 1102. Dipole arms of the dipole antenna of the overlapped dipole can be printed on respective surfaces of a first substrate 1114. By way of example, a curve in the transition from the dipole arms (e.g., curved dipole arms) to the CPS (e.g., the conductors of the dipole antenna) can provide smoother impedance matching. In such an example, a copper layer can be printed at a bottom of a second substrate 1116 representing a ground plane of the dipole antenna or TCDA.

Model 1104 illustrates a first step of applying a CM inductor 1118 to a dipole antenna. The CM inductor can be selected or constructed based on the CM resonance of the dipole antenna. For example, the CM inductor can be selected or constructed based on the simulations, determinations, and models of FIGS. 2-8.

Model 1106 illustrates a second step of printing a tapered-slot antenna 1110 above an overlapped dipole arm on a surface of the first substrate (e.g., the substrate including the dipole arms and conductors of the dipole antenna). In some examples, the tapered slot-antenna can be constructed of a frequency selective surface (FSS). In such an example, the FSS can be selected based on the signal frequencies to which the dipole antenna is intended to receive or transmit. The sliced tapered-slot antenna can include tapered metal fins to provide spatial impedance matching between dipole arms and free space (e.g., gaps in the dipole antenna or gaps between dipole antennas of a TCDA array).

The tapered-slot antenna 1110 can provide impedance matching between the dipole antenna and a port (e.g., a transmitting port or receiving port of a device transmitting or receiving signals from the dipole antenna). Techniques such as gradual slot line design can be used to realize smooth impedance transformation of the dipole antenna to adjust signal reflections of the dipole antenna.

In the second step, a tapered-slot antenna can be printed above an overlapped dipole arm to provide spatial impedance matching between dipole arms and free space. Printing the tapered-slot above the overlapped dipole arm can increase cross-polarization levels. Increases to cross-polarization can disturb signal transmissions. The printed tapered-slot antenna can be cut into slides (e.g., further described in the third step) which can cause cross-polarization levels to be lower as the gap blocks the vertical currents. The number of slices and gap size can be adjusted and selected to minimize cross-polarization levels (e.g., to reduce disturbances to signal transmissions).

Model 1108 illustrates a third step of cutting (e.g., dividing or portioning) a tapered-slot antenna into slices or divisions to generate a sliced tapered-slot antenna 1112. The sliced tapered-slot antenna 1112 can be used to adjust cross-polarization (cro-pol) levels of the dipole antenna or TCDA. The slices can be parallel or substantially parallel. In further examples, the spacing of slices can be adjusted (e.g., gaps between slices represented by gp). In such an example, generally increases in gaps can increase the impedance of the tapered-slot antenna. By way of a non-limiting example, the sliced tapered-slot antenna 1112 is divided into nine slices.

FIG. 11 includes Table III illustrating design parameters of the sliced-tapered-slot antenna including substrates used and dimensions of a dipole antenna and sliced-tapered slot antenna. For example, the first substrate can be RT/duroid 5880 and the second substrate can be FR4 KB-6160. In such an example, the RT/duroid 5880 can have a thickness of less than 0.8 mm (e.g., 0.787 mm as shown in Table III). In some embodiments, the thickness may be from 0.1 to 0.2 mm, 0.2 to 0.3 mm, 0.3 to 0.4 mm, 0.4 to 0.5 mm, 0.5 to 0.6 mm, 0.6 to 0.7 mm, 0.7 to 0.8 mm, or 0.8 to 1.0 mm.

### VIII. Sliced Tapered-Slot FSS Analysis

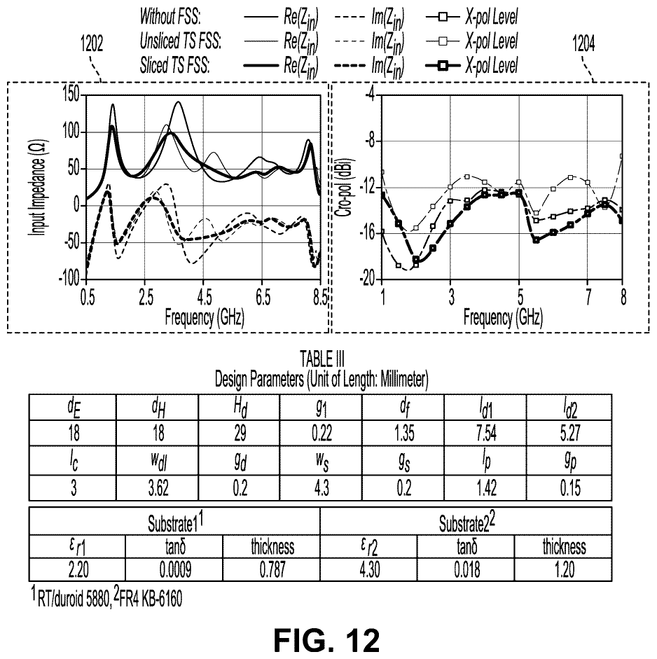

FIG. 12 is a block diagram including a first line graph 1202 illustrating input impedance of a dipole antenna with a tapered-slot antenna, without a tapered-slot antenna, and with a sliced tapered-slot antenna. As shown in FIG. 12, including a sliced tapered-slot antenna can reduce an input impedance of the dipole antenna.

FIG. 12 includes a second line graph 1204 illustrating an example of adjustments to cro-pol associated with a dipole antenna without a tapered-slot antenna, with a tapered-slot antenna, and with a sliced tapered-slot antenna. The second line graph 1204 indicates cro-pol levels when scanning in non-principal plane can deteriorate at around 3 dB in part due to vertical currents flowing along edges of the tapered-slot antenna. By slicing the tapered-slot antenna in a direction perpendicular to the conductors of a dipole antenna, the vertical currents can be interrupted lowering interference to the dipole antenna.

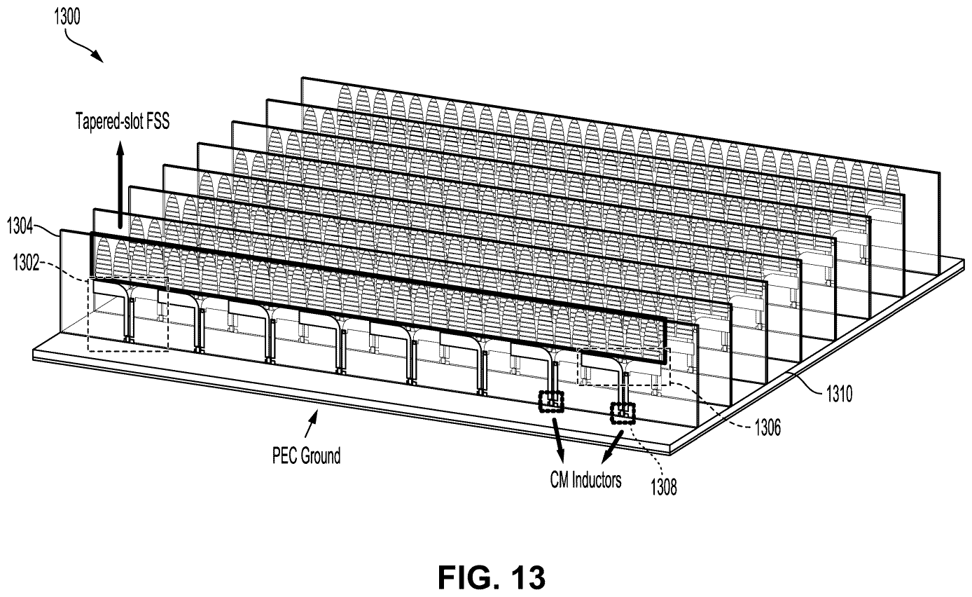

FIG. 13 illustrates an example tightly coupled dipole antenna (TCDA) array 1300 including a plurality of dipole antennas 1302 attached (or printed in or on) to a first substrate 1304 oriented along a first plane. Dipole arms 1306 of one or more dipole antennas can overlap. In some examples, the dipole arms 1306 overlap on opposite sides of the first substrate 1304 (e.g., a first dipole arm on a first side of the first substrate 1304 and a second dipole arm on a second side of the first substrate 1304). The plurality of dipole antennas 1302 include respective CM inductors 1308. The CM inductors 1308 can be modeled, simulated, and constructed according to the description of FIGS. 2-8. The CM inductors 1308 can be attached to conductors (e.g., transmission lines) of respective dipole antennas. In some examples, a CM inductor 1308 can be attached to the conductors of a dipole antenna at a first end of the CM inductor and to another transmission line of the TCDA or a second substrate 1310 at a second end of the CM inductor. In some examples, the second substrate 1310 is made of a different material from the first substrate 1304. In another example, the first substrate can be less than 0.8 millimeters thick, as illustrated in Table III of FIG. 11. In further examples, the second substrate 1310 can be oriented along a second plane. The second plane can be substantially orthogonal to the first plane. In some examples, the second substrate 1310 can be a ground plane. In further examples, the second substrate 1310 can include a copper lining or other conductor printed on or within the second substrate 1310 to connect the plurality of dipole antennas 1302 to other components of a wireless communications system. The number of dipole antennas and rows of dipole antennas can be adjusted. For example, a TCDA can include dozens or more dipole antennas per row, and dozens of rows. As a non-limiting example, the TCDA can have two to fifty dipole antennas in a row and two to fifty rows.

### IX. Example Methods

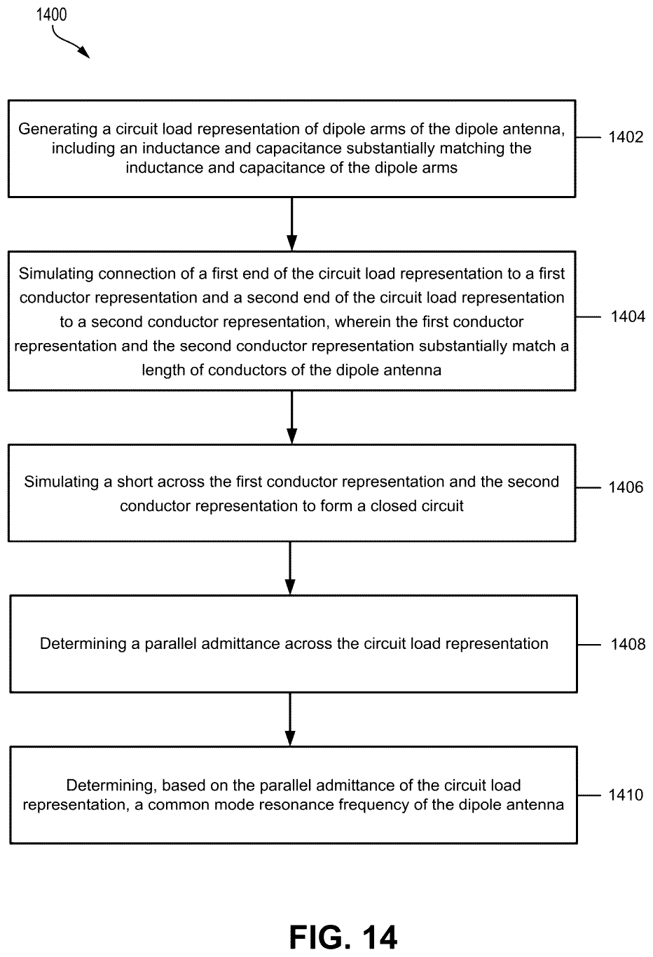

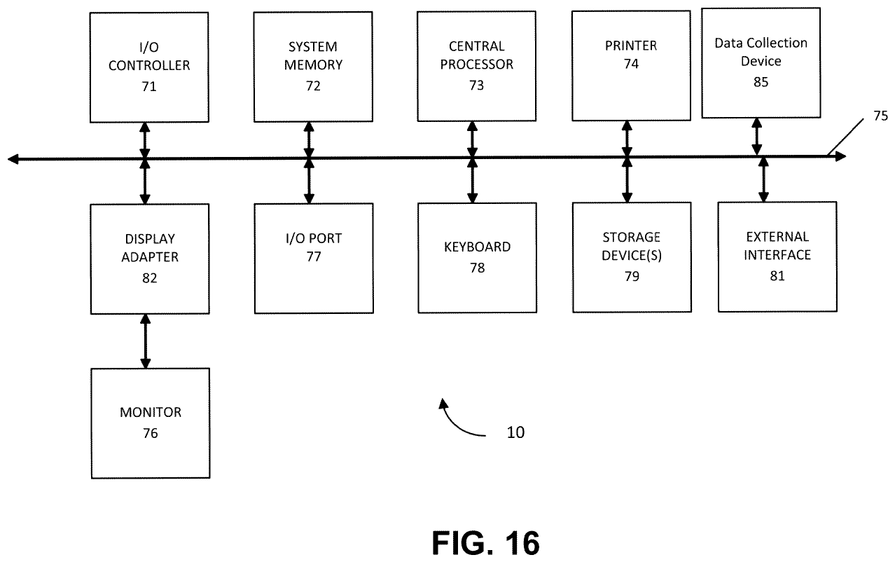

FIG. 14 is a flowchart of an example process 1400 for predicting and suppressing common mode resonance (e.g., common mode resonance of a dipole antenna or TCDA). In some implementations, one or more process blocks of FIG. 14 may be performed by another device, or a group of devices separate from or including the system. Additionally, or alternatively, one or more process blocks of FIG. 14 may be performed by one or more components of computer system 10 of FIG. 16, such as central processor 73.

At block 1402, the computer system (or component thereof) can generate a circuit load representation of dipole arms of the dipole antenna. The circuit load representation can include lan inductance and capacitance substantially matching the inductance and capacitance of the dipole arms. For example, the computer system (or component thereof) can determine the circuit load representation of dipole arms of the antenna using model 208 of FIG. 2 and analysis techniques provided in the description of FIGS. 2-8.

At block 1404, the computer system (or component thereof) can simulate connection of a first end of the circuit load representation to a first conductor representation and a second end of the circuit load representation to a second conductor representation. In such an example, the first conductor representation and the second conductor representation substantially match a length of conductors of the dipole antenna to be simulated. For example, the circuit load representation can be a mathematical representation of the dipole antenna to be simulated, including dimensions of the dipole antenna. In further examples, a user can construct a physical circuit load representation of the dipole antenna. The conductor representations can be mathematical representations of transmission line (e.g., conductors or conductive elements) of the dipole antenna to be simulated.

At block 1406, the computer system (or component thereof) can simulate a short across the first conductor representation and the second conductor representation to form a closed circuit.

At block 1408, the computer system (or component thereof) can determine a parallel admittance across the circuit load representation. For example, the parallel admittance can be determined based on the admittance of dipole arms of the dipole antenna to be simulated. In such an example, various analysis techniques for determining admittance of the dipole arms are provided in the description of FIGS. 2-10.

At block 1410, the computer system (or component thereof) can determine (or predict), based on the parallel admittance of the circuit load representation, a common mode resonance frequency of the dipole antenna to be simulated. For example, the common mode resonance frequency can be predicted using the analysis techniques provided in the description of FIGS. 6-10.

In further examples, the process 1400 can further include using the computer system (or component thereof) to measure inductance and capacitance of the dipole arms of the dipole antenna. In such an example, the parallel admittance across the circuit load representation can be based in part on measured inductance and capacitance of the dipole arms of the dipole antenna to be simulated. In another example, the process 1400 can include using the computer system (or component thereof) to generate a resonator based on the parallel admittance of the circuit load representation. The resonator can include a parallel admittance substantially matching the parallel admittance of the circuit load representation. In some examples, the resonator is an inductor, such as the CM inductor. The process can include using the computer system (or component thereof) to simulate application of the resonator to the dipole antenna, such as by simulating application of the resonator to a first conductor of the dipole antenna (or conductor representation of the circuit load representation) and to a second conductor of the dipole antenna (or conductor representation of the circuit load representation). In some examples, the process 1400 can include using the computer system (or component thereof) to simulate connection of the resonator (e.g., the CM inductor) to an additional pair of conductors connected to a substrate substantially orthogonal to the dipole antenna. In further examples, the process 1400 can include constructing the dipole antenna and the resonator based on the simulations. In further examples, the circuit load representation of the dipole arms is an inductor-capacitor (LC) circuit. In such an example, the LC circuit can include a first circuit, and a second circuit connected in parallel. The first circuit can include a first capacitor and a first inductor in series. The second circuit can include a second capacitor and a second inductor in series. In another example, the first circuit can be associated with a first dipole arm of the dipole antenna and the second circuit can be associated with a second dipole arm of the dipole antenna.

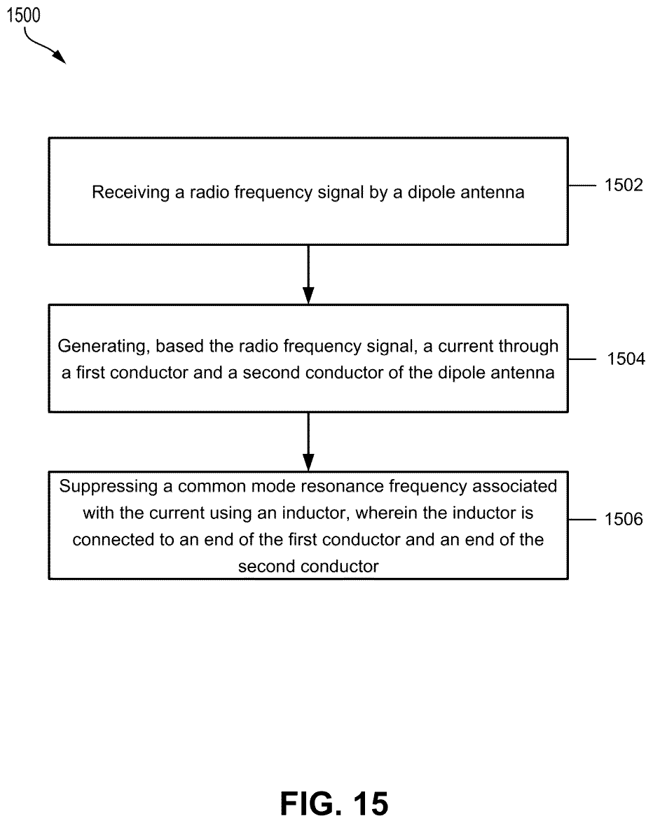

FIG. 15 is a flowchart of an example process 1500 for predicting and suppressing common mode resonance (e.g., common mode resonance of a dipole antenna or TCDA). In some implementations, one or more process blocks of FIG. 15 may be performed by another device, or a group of devices separate from or including the system. Additionally, or alternatively, one or more process blocks of FIG. 14 may be performed by one or more components of computer system 10 of FIG. 16, such as central processor 73.

At block 1502, the process 1500 can include receiving a radio frequency signal by a dipole antenna. For example, the dipole antenna can be the dipole antenna or TCDA described in the description of FIG. 11. The dipole antenna can receive a radio frequency signal, such as a UWB signal between 3.1 GHz to 10.6 GHz.

At block 1504, the process 1500 can include generating, based the radio frequency signal, a current through a first conductor and a second conductor of the dipole antenna. For example, the radio frequency signal can excite a current through the first conductor and the second conductor of the dipole antenna.

At block 1506, the process 1500 can include suppressing a common mode resonance frequency associated with the current using an inductor. For example, suppressing a common mode resonance can include connecting the inductor to an end of the first conductor and to an end of the second conductor. In such an example, the inductor can be selected or constructed based on the common mode resonance of the dipole antenna. In some examples, the first conductor can include a first conductive arm connected substantially perpendicular to a first end of the first conductor and oriented along a first plane, and a second conductive arm connected substantially perpendicular to a first end of the second conductor and oriented along the first plane.

In another example, the process 1500 can include receiving an additional radio frequency signal by a tapered-slot antenna. In such an example, the tapered-slot antenna can be divided into a plurality of portions with gaps between adjacent portions. The divisions can be substantially parallel to the first conductive arm and the second conductive arm of the dipole antenna. In some examples, the additional radio frequency signal can be the same signal as the radio frequency signal. The process 1500 can further include generating, based on the additional radio frequency signal, an additional current through a portion of the tapered-slot antenna in a direction perpendicular to the current through the first conductor and the second conductor. For example, the additional radio frequency signal can excite a current through the portion of the tapered-slot antenna. In another example, the tapered-slot antenna can be divided into a plurality of portions with gaps between adjacent portions. In another example, the tapered-slot antenna can be divided into portions in a direction perpendicular to the first conductor and the second conductor. In a further example, the tapered slot antenna can include a frequency selective surface (FSS).

### X. Example System

Any of the computer systems mentioned herein may utilize any suitable number of subsystems. Examples of such subsystems are shown in FIG. 16 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones, other mobile devices, and cloud-based systems.

The subsystems shown in FIG. 16 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, Lightning, Thunderbolt™). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a,” “an”, or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted being prior art.

### Aspects:

The present technology includes computer-readable storage mediums for storing instructions, and systems for executing any one of the methods embodied in the instructions addressed in the aspects of the present technology presented below:
Aspect 1. An apparatus comprising: a first dipole antenna comprising: a first conductor and a second conductor substantially in parallel and oriented along a first plane; a first conductive arm connected substantially perpendicular to a first end of the first conductor and oriented along the first plane; and a second conductive arm connected substantially perpendicular to a first end of the second conductor and oriented along the first plane; and an inductor connected to a second end of the first conductor and a second end of the second conductor, the inductor associated with an inductance to substantially filter a common mode resonance frequency of the first dipole antenna.
Aspect 2. The apparatus of Aspect 1, further comprising: a tapered-slot antenna substantially in parallel with the first conductive arm and the second conductive arm.
Aspect 3. The apparatus of Aspect 2, wherein the tapered-slot antenna is divided into a plurality of portions with gaps between adjacent portions.
Aspect 4. The apparatus of Aspect 3, wherein the tapered-slot antenna is divided into portions in a direction perpendicular to the first conductor and the second conductor.
Aspect 5. The apparatus of Aspect 4, wherein the tapered-slot antenna includes a frequency selective surface (FSS).
Aspect 6. The apparatus of Aspect 2, wherein the first dipole antenna further comprises: a first substrate oriented along the first plane, wherein the first conductor, the second conductor, the first conductive arm, the second conductive arm, and the tapered-slot antenna are attached to the first substrate.
Aspect 7. The apparatus of Aspect 6, wherein the first conductive arm is attached to a first surface of the first substrate and the second conductive arm is attached to a second surface of the first substrate.
Aspect 8. The apparatus of Aspect 7, the apparatus further comprising: a second dipole antenna connected to the first substrate comprising: a third conductor and a fourth conductor substantially parallel to the first conductor and the second conductor of the first dipole antenna and oriented along the first plane; a third conductive arm connected substantially perpendicular to a first end of the third conductor and oriented along the first plane; and a fourth conductive arm connected substantially perpendicular to a first end of the fourth conductor and oriented along the first plane; and a second inductor connected to a second end of the third conductor, a second end of the fourth conductor, wherein the inductor is associated with an inductance to substantially filter a common mode resonance frequency of the second dipole antenna.
Aspect 9. The apparatus of Aspect 8, wherein the first conductive arm of the first dipole antenna and the third conductive arm of the second dipole antenna overlap.
Aspect 10. The apparatus of Aspect 7, wherein the inductor is connected to an additional pair of conductors attached to a second substrate along a second plane, wherein the second plane is substantially orthogonal to the first plane.
Aspect 11. The apparatus of Aspect 10, the apparatus further comprising: a second dipole antenna comprising: a third conductor and a fourth conductor substantially parallel to the first conductor and the second conductor of the first dipole antenna and oriented along a third plane in parallel with the first plane; a third conductive arm connected substantially perpendicular to a first end of the third conductor and oriented along the third plane; and a fourth conductive arm connected substantially perpendicular to a first end of the fourth conductor and oriented along the third plane; and a second inductor connected to a second end of the third conductor, a second end of the fourth conductor, wherein the inductor is associated with an inductance to substantially filter a common mode resonance frequency of the second dipole antenna.
Aspect 12. The apparatus of Aspect 10, wherein the first substrate and the second substrate are different materials.
Aspect 13. The apparatus of Aspect 12, wherein the first substrate is less than 0.8 millimeters thick.
Aspect 14. A method of suppressing common mode resonance of a dipole antenna, the method comprising: generating a circuit load representation of dipole arms of the dipole antenna, including an inductance and capacitance substantially matching the inductance and capacitance of the dipole arms; simulating connection of a first end of the circuit load representation to a first conductor representation and a second end of the circuit load representation to a second conductor representation, wherein the first conductor representation and the second conductor representation substantially match a length of conductors of the dipole antenna; simulating a short across the first conductor representation and the second conductor representation to form a closed circuit; determining a parallel admittance across the circuit load representation; and determining, based on the parallel admittance of the circuit load representation, a common mode resonance frequency of the dipole antenna.
Aspect 15. The method of Aspect 14, further comprising: measuring inductance and capacitance of the dipole arms of the dipole antenna.
Aspect 16. The method of Aspect 14, further comprising: generating a resonator based on the parallel admittance of the circuit load representation, the resonator having a parallel admittance substantially matching the parallel admittance of the circuit load representation; and simulating application of the resonator to the dipole antenna.
Aspect 17. The method of Aspect 16, wherein the resonator is an inductor.
Aspect 18. The method of Aspect 16, wherein the resonator is applied to a first conductor of the dipole antenna and to a second conductor of the dipole antenna.
Aspect 19. The method of Aspect 18, further comprising: simulating connection of the resonator to an additional pair of conductors connected to a substrate substantially orthogonal to the dipole antenna.
Aspect 20. The method of Aspect 19, further comprising: constructing the dipole antenna and the resonator based on simulating the connection of the resonator to the additional pair of conductors.
Aspect 21. The method of Aspect 14, wherein the circuit load representation of the dipole arms is an inductor-capacitor (LC) circuit.
Aspect 22. The method of Aspect 21, wherein the LC circuit includes a first circuit and a second circuit connected in parallel, the first circuit including a first capacitor and a first inductor in series, and the second circuit including a second capacitor and a second inductor in series.
Aspect 23. The method of Aspect 22, wherein the first circuit is associated with a first dipole arm of the dipole antenna and the second circuit is associated with a second dipole arm of the dipole antenna.
Aspect 24. A method comprising: receiving a radio frequency signal by a dipole antenna; generating, based the radio frequency signal, a current through a first conductor and a second conductor of the dipole antenna; and suppressing a common mode resonance frequency associated with the current using an inductor, wherein the inductor is connected to an end of the first conductor and an end of the second conductor.
Aspect 25. The method of Aspect 24, wherein the first conductor includes a first conductive arm connected substantially perpendicular to a first end of the first conductor and oriented along a first plane, and a second conductive arm connected substantially perpendicular to a first end of the second conductor and oriented along the first plane.
Aspect 26. The method of Aspect 24, further comprising: receiving an additional radio frequency signal by a tapered-slot antenna, the tapered-slot antenna divided into a plurality of portions with gaps between adjacent portions, wherein the plurality of portions is substantially parallel to the first conductor and the second conductor; and generating, based on the additional radio frequency signal, an additional current through a portion of the tapered-slot antenna in a direction perpendicular to the current through the first conductor and the second conductor.
Aspect 27. The method of Aspect 26, wherein the tapered-slot antenna is divided into a plurality of portions with gaps between adjacent portions.
Aspect 28. The method of Aspect 26, wherein the tapered-slot antenna is divided into portions in a direction perpendicular to the first conductor and the second conductor.
Aspect 29. The method of Aspect 26, wherein the tapered-slot antenna includes a frequency selective surface.

What is claimed is:

1. An apparatus comprising:
a first dipole antenna comprising:
a first conductor and a second conductor substantially in parallel and oriented along a first plane,
a first conductive arm connected substantially perpendicular to a first end of the first conductor and oriented along the first plane, and
a second conductive arm connected substantially perpendicular to a first end of the second conductor and oriented along the first plane; and
an inductor connected to a second end of the first conductor and a second end of the second conductor, the inductor associated with an inductance to substantially filter a common mode resonance frequency of the first dipole antenna.

2. The apparatus of claim 1, further comprising:
a tapered-slot antenna substantially in parallel with the first conductive arm and the second conductive arm.

3. The apparatus of claim 2, wherein the tapered-slot antenna is divided into a plurality of portions with gaps between adjacent portions.

4. The apparatus of claim 3, wherein the tapered-slot antenna is divided into portions in a direction perpendicular to the first conductor and the second conductor.

5. The apparatus of claim 4, wherein the tapered-slot antenna includes a frequency selective surface (FSS).

6. The apparatus of claim 2, wherein the first dipole antenna further comprises:
a first substrate oriented along the first plane, wherein the first conductor, the second conductor, the first conductive arm, the second conductive arm, and the tapered-slot antenna are attached to the first substrate.

7. The apparatus of claim 6, wherein the first conductive arm is attached to a first surface of the first substrate and the second conductive arm is attached to a second surface of the first substrate.

8. The apparatus of claim 7, the apparatus further comprising:
a second dipole antenna connected to the first substrate comprising:
a third conductor and a fourth conductor substantially parallel to the first conductor and the second conductor of the first dipole antenna and oriented along the first plane,
a third conductive arm connected substantially perpendicular to a first end of the third conductor and oriented along the first plane, and
a fourth conductive arm connected substantially perpendicular to a first end of the fourth conductor and oriented along the first plane; and
a second inductor connected to a second end of the third conductor, a second end of the fourth conductor, wherein the inductor is associated with an inductance to substantially filter a common mode resonance frequency of the second dipole antenna.

9. The apparatus of claim 7, wherein the inductor is connected to an additional pair of conductors attached to a second substrate along a second plane, wherein the second plane is substantially orthogonal to the first plane.

10. The apparatus of claim 9, the apparatus further comprising:
a second dipole antenna comprising:
a third conductor and a fourth conductor substantially parallel to the first conductor and the second conductor of the first dipole antenna and oriented along a third plane in parallel with the first plane,
a third conductive arm connected substantially perpendicular to a first end of the third conductor and oriented along the third plane, and
a fourth conductive arm connected substantially perpendicular to a first end of the fourth conductor and oriented along the third plane; and
a second inductor connected to a second end of the third conductor, a second end of the fourth conductor, wherein the inductor is associated with an inductance to substantially filter a common mode resonance frequency of the second dipole antenna.

11. A method of suppressing common mode resonance of a dipole antenna, the method comprising:
generating a circuit load representation of dipole arms of the dipole antenna, including an inductance and capacitance substantially matching the inductance and capacitance of the dipole arms;
simulating connection of a first end of the circuit load representation to a first conductor representation and a second end of the circuit load representation to a second conductor representation, wherein the first conductor representation and the second conductor representation substantially match a length of conductors of the dipole antenna;
simulating a short across the first conductor representation and the second conductor representation to form a closed circuit;
determining a parallel admittance across the circuit load representation; and
determining, based on the parallel admittance of the circuit load representation, a common mode resonance frequency of the dipole antenna.

12. The method of claim 11, further comprising:
measuring inductance and capacitance of the dipole arms of the dipole antenna.

13. The method of claim 11, further comprising:
generating a resonator based on the parallel admittance of the circuit load representation, the resonator having a parallel admittance substantially matching the parallel admittance of the circuit load representation; and
simulating application of the resonator to the dipole antenna.

14. The method of claim 13, wherein the resonator is an inductor.

15. The method of claim 13, wherein the resonator is applied to a first conductor of the dipole antenna and to a second conductor of the dipole antenna.

16. A method comprising:
receiving a radio frequency signal by a dipole antenna;
generating, based the radio frequency signal, a current through a first conductor and a second conductor of the dipole antenna; and
suppressing a common mode resonance frequency associated with the current using an inductor, wherein the inductor is connected to an end of the first conductor and an end of the second conductor.

17. The method of claim 16, wherein the first conductor includes a first conductive arm connected substantially perpendicular to a first end of the first conductor and oriented along a first plane, and a second conductive arm connected substantially perpendicular to a first end of the second conductor and oriented along the first plane.

18. The method of claim 16, further comprising:
receiving an additional radio frequency signal by a tapered-slot antenna, the tapered-slot antenna divided into a plurality of portions with gaps between adjacent portions, wherein the plurality of portions is substantially parallel to the first conductor and the second conductor; and
generating, based on the additional radio frequency signal, an additional current through a portion of the tapered-slot antenna in a direction perpendicular to the current through the first conductor and the second conductor.

19. The method of claim 18, wherein the tapered-slot antenna is divided into a plurality of portions with gaps between adjacent portions.

20. The method of claim 18, wherein the tapered-slot antenna is divided into portions in a direction perpendicular to the first conductor and the second conductor.
